(19) United States
(12) Patent Application Publication
(10) Pub. No.: US 2019/0124953 A1
(43) Pub. Date: May 2, 2019

(54) NOVEL STEVIOL GLYCOSIDES BLENDS

(71) Applicant: PEPSICO, INC., Purchase, NY (US)

(72) Inventors: Laura NATTRESS, Tarrytown, NY (US); Rashmi TIWARI, White Plains, NY (US); Brittany YEE, Tarrytown, NY (US)

(73) Assignee: PEPSICO, INC., Purchase, NY (US)

(21) Appl. No.: 16/095,493

(22) PCT Filed: Apr. 28, 2017
(86) PCT No.: PCT/US2017/030111

§ 371 Date: Oct. 22, 2018

Related U.S. Application Data
(60) Provisional application No. 62/329,527, filed on Apr. 29, 2016.

(51) Int. Cl. A23L 2/60; A23L 27/30

(52) U.S. Cl. CPC A23L 2/60; A23V 2002/00; A23L 27/34; A23L 27/36

(57) ABSTRACT

The present disclosure provides sweetener compositions containing steviol glycosides blends to mitigate the bitterness of and off-state of steviol glycosides. In particular, the sweetener compositions include rebaudioside A, rebaudioside D, rebaudioside M, erythritol, and D-allulose. The present disclosure is further directed to beverages containing such steviol glycosides blends.

### FIELD OF DISCLOSURE

The present disclosure is directed to novel steviol glycosides blends having an improved flavor profile. These blends can be used as a dry sweetener composition, in foods and beverages, and in beverage concentrates.

### BACKGROUND

The plant species Stevia rebaudiana produces a number of diterpene glycosides suitable for use as high-potency, non-caloric sweeteners in consumable products. The glycosides isolable from Stevia rebaudiana include, but are not limited to, stevioside, rebaudioside A, rebaudioside C, dulcoside A, rubusoside, steviolbioside, rebaudioside B, rebaudioside D, rebaudioside E, rebaudioside F, and rebaudioside M.

Despite having sweetening properties, steviol glycosides and blends of these compounds often exhibit unfavorable properties including delayed sweetness onset, lingering sweet aftertastes, bitter tastes, metallic tastes, astringent tastes, cooling tastes, and/or licorice-like tastes. These unfavorable properties make it difficult to prepare a product having an acceptable flavor profile when using these compounds.

What is more, steviol glycosides target several different bitter receptors, making it even more difficult to mitigate bitterness associated with the compounds. While flavor modifiers, bitterness masking agents, and steviol glycoside blends have been used in the past to overcome the inherent difficulties associated with the steviol glycosides, there is still a need to develop improved steviol glycoside compositions having a suitable flavor profile for use in consumable products.

### SUMMARY

The present disclosure provides sweetener compositions, beverages, such as zero- or reduced-calorie beverages, and concentrates containing novel steviol glycosides blends that have an improved flavor profile.

The present disclosure provides a sweetener composition comprising rebaudioside A, rebaudioside D, rebaudioside M, erythritol, and D-allulose, wherein:

rebaudioside A and rebaudioside D are present in a weight ratio in a range of from 2.2:1 to 1.8:1;

rebaudioside A and rebaudioside M are present in a weight ratio in a range of from 2.2:1 to 1.8:1;

rebaudioside A and erythritol are present in a weight ratio in a range of from 1:110 to 1:140; and

rebaudioside A and D-allulose are present in a weight ratio in a range of from 1:90 to 1:120.

In certain embodiments, the weight ratio of rebaudioside A to rebaudioside D is in a range of from 2.1:1 to 1.9:1. In certain embodiments, the weight ratio of rebaudioside A to rebaudioside D is 2:1.

In certain embodiments, the weight ratio of rebaudioside A to rebaudioside M is in a range of from 2.1:1 to 1.9:1. In certain embodiments, the weight ratio of rebaudioside A to rebaudioside M is 2:1.

In certain embodiments, the weight ratio of rebaudioside A to erythritol is in the range of from 1:120 to 1:130. In certain embodiments, the weight ratio of rebaudioside A to erythritol is 1:125.

In certain embodiments, the weight ratio of rebaudioside A to D-allulose is in a range of from 1:100 to 1:110. In certain embodiments, the weight ratio of rebaudioside A to D-allulose is 1:105.

The present disclosure also provides a zero- or reduced-calorie beverage comprising rebaudioside A, rebaudioside D, rebaudioside M,
wherein rebaudioside A and rebaudioside D are present in a weight ratio in a range of from 2.2:1 to 1.8:1,
wherein rebaudioside A and rebaudioside M are present in a weight ratio in a range of from 2.2:1 to 1.8:1, and
wherein the beverage further comprises erythritol and D-allulose.

In certain embodiments, the weight ratio of rebaudioside A to rebaudioside D in the beverage is in a range of from 2.1:1 to 1.9:1. In certain embodiments, the weight ratio of rebaudioside A to rebaudioside D is 2:1.

In certain embodiments, the weight ratio of rebaudioside A to rebaudioside M in the beverage is in a range of from 2.1:1 to 1.9:1. In certain embodiments, the weight ratio of rebaudioside A to rebaudioside M is 2:1.

In certain embodiments, rebaudioside A is present in a concentration of from 180 ppm to 220 ppm in the beverage.

In certain embodiments, rebaudioside D is present in a concentration of from 80 ppm to 120 ppm in the beverage.

In certain embodiments, rebaudioside M is present in a concentration of from 80 ppm to 120 ppm in the beverage.

In certain embodiments, erythritol is present in a concentration of from 2% to 3% by weight of the beverage. In certain embodiments, erythritol is present in a concentration of 2.5% by weight of the beverage.

In certain embodiments, D-allulose is present in a concentration of from 1.6% to 2.6% by weight of the beverage. In certain embodiments, D-allulose is present in a concentration of 2.1% by weight of the beverage.

In certain embodiments, the zero- or reduced-calorie beverage described herein is selected from the group consisting of enhanced sparkling beverage, cola, lemon-lime flavored sparkling beverage, orange flavored sparkling beverage, grape flavored sparkling beverage, strawberry flavored sparkling beverage, grape flavored sparkling beverage, pineapple flavored sparkling beverage, ginger-ale, soft drink, root beer, fruit juice, fruit-flavored juice, juice drink, nectar, vegetable juice, vegetable-flavored juice, sports drink, energy drink, enhanced water drink, coconut water, tea-type drink, coffee, cocoa drink, beverage containing milk components, beverage containing cereal extract, frozen beverage, and a smoothie.

In certain embodiments, the zero- or reduced-calorie beverage further comprises at least one functional ingredient selected from the group consisting of saponin, antioxidant, dietary fiber source, fatty acid, vitamin, glucosamine, mineral, preservative, hydration agent, probiotic, prebiotic, weight management agent, osteoporosis management agent, phytoestrogen, long chain primary aliphatic saturated alcohol, phytosteroland, and combinations thereof.

In addition, the present disclosure provides a beverage comprising water, an acid, rebaudioside A, rebaudioside D, rebaudioside M, erythritol, and D-allulose, wherein rebaudioside A is present in the beverage in a concentration ranging from about 100 ppm to about 300 ppm and wherein each of rebaudiosides D and M is present in the beverage in a concentration ranging from about 50 ppm to about 150 ppm; further wherein: a ratio of the concentrations of rebaudioside A to rebaudioside D is about 2:1; a ratio of the concentrations of rebaudioside A to rebaudioside M is about 2:1; D-allulose is present in a sweetening amount, but not more than about 2.1 weight percent; and erythritol is present in a sweetening amount, but not more than about 2.5 weight percent.

In some embodiments, the concentration of rebaudioside A is about 100 ppm. In some embodiments, the concentration of rebaudioside A is about 200 ppm.

In some embodiments, the beverage exhibits a statistically significant reduction in sourness relative to a comparative beverage comprising 200 ppm rebaudioside M, 100 ppm rebaudioside A, and 100 pm rebaudioside D.

In some embodiments, the beverage exhibits a statistically significant increase in sweetness relative to a comparative beverage comprising 200 ppm rebaudioside M, 100 ppm rebaudioside A, and 100 pm rebaudioside D.

In some embodiments, the beverage exhibits a statistically significant increase in speed of sweetness onset relative to a comparative beverage comprising 200 ppm rebaudioside M, 100 ppm rebaudioside A, and 100 pm rebaudioside D.

In some embodiments, the beverage exhibits a statistically significant reduction in total aftertaste relative to a comparative beverage comprising 200 ppm rebaudioside M, 100 ppm rebaudioside A, and 100 pm rebaudioside D.

In some embodiments, the beverage exhibits a statistically significant increase in sweet aromatics relative to a comparative beverage comprising 200 ppm rebaudioside M, 100 ppm rebaudioside A, and 100 pm rebaudioside D.

In some embodiments, the beverage exhibits a statistically significant increase of sweetness in sweet adaption at about 10 seconds relative to a comparative beverage comprising 200 ppm rebaudioside M, 100 ppm rebaudioside A, and 100 pm rebaudioside D.

In some embodiments, the beverage exhibits a statistically significant reduction of bitterness in bitter sensitization at about 180 seconds relative to a comparative beverage comprising 200 ppm rebaudioside M, 100 ppm rebaudioside A, and 100 pm rebaudioside

D.

In some embodiments, the statistical significance observed for the characteristics of the beverage disclosed herein is observed at at least an 80% confidence level, at least an 85% confidence level, or at least an 90% confidence level.

The present disclosure also provides a beverage syrup comprising water, an acid, rebaudioside A, rebaudioside D, rebaudioside M, erythritol, and D-allulose, wherein rebaudioside A is present in the beverage in a concentration ranging from about 600 ppm to about 1200 ppm and wherein each of rebaudiosides D and M is present in the syrup in a concentration ranging from about 300 ppm to about 600 ppm; further wherein: a ratio of the concentrations of rebaudioside A to rebaudioside D is about 2:1; a ratio of the concentrations of rebaudioside A to rebaudioside M is about 2:1; D-allulose is present in an amount of at least 6.3 weight percent, but not more than about 12.6 weight percent; and erythritol is present in an amount of at least 7.5 weight percent, but not more than about 15 weight percent.

### BRIEF DESCRIPTION OF THE DRAWINGS

The foregoing summary, as well as the following detailed description of the embodiments, will be better understood when read in conjunction with the appended figures. For the purpose of illustration, the figures can describe the use of specific embodiments. It should be understood, however, that the formulations and compositions described herein are not limited to the precise embodiments discussed or described in the figures.

FIG. 1 depicts the overall impressions of a trained sensory panel evaluating the performance of various sweetener compositions described herein.

FIGS. 2-4 depict a sensory comparison of rebaudioside A to rebaudioside M in a citric acid solution.

FIGS. 5-7 depict a sensory comparison of rebaudioside A to rebaudioside D in a citric acid solution.

FIGS. 8-10 depict a sensory comparison of rebaudioside A to a combination of rebaudiosides A, D, and M in a citric acid solution.

FIGS. 11-13 depict a sensory comparison of rebaudioside A to a combination of rebaudiosides A, D, M and D-allulose in a citric acid solution.

FIGS. 14-16 depict a sensory comparison of rebaudioside A to a combination of rebaudiosides A, D, M and erythritol in a citric acid solution.

FIG. 17 depicts sour taste intensity of rebaudiosides A, D, M, and combinations thereof in a citric acid solution at various time points.

FIG. 18 depicts artificial/chemical off-note of rebaudiosides A, D, M, and combinations thereof in a citric acid solution at various time points.

FIG. 19 depicts sweet and sour taste intensity of samples 40 and 41.

FIG. 20 depicts sweet aromatics intensity of samples 40 and 41.

FIG. 21 depicts total aftertaste intensity of samples 40 and 41.

FIG. 22 depicts sweetness onset speed of samples 40 and 41.

FIG. 23 depicts sweet adaptation of samples 40 and 41.

FIG. 24 depicts bitter sensitization of samples 40 and 41.

FIG. 25 depicts overall impression of 400 ppm rebaudioside A and samples 40 and 41.

FIG. 26 depicts data from Targeted Descriptive Analysis of sample 40 by trained panelists, including ratings on first impression, sweetness, sourness, bitterness, sweet aromatics, and anise/licorice taste,

FIG. 27 depicts data from Targeted Descriptive Analysis of sample 40 by trained panelists, including ratings on metallic taste, astringency, viscosity, chemical/artificial taste, total aftertaste, and speed of sweetness onset.

FIG. 28 depicts data from Targeted Descriptive Analysis of sample 41 by trained panelists, including ratings on first impression, sweetness, sourness, bitterness, sweet aromatics, and anise/licorice taste.

FIG. 29 depicts data from Targeted Descriptive Analysis of sample 41 by trained panelists, including ratings on metallic taste, astringency, viscosity, chemical/artificial taste, total aftertaste, and speed of sweetness onset.

### DETAILED DESCRIPTION

Various examples and embodiments of the inventive subject matter disclosed here are possible and will be apparent to the person of ordinary skill in the art, given the benefit of this disclosure. In this disclosure reference to “some embodiments,” “certain embodiments,” “certain exemplary embodiments” and similar phrases each means that those embodiments are non-limiting examples of the inventive subject matter, and there are alternative embodiments which are not excluded.

The articles “a,” “an,” and “the” are used herein to refer to one or to more than one (i.e., to at least one) of the grammatical object of the article. By way of example, “an element” means one element or more than one element.

The word “comprising” is used in a manner consistent with its open-ended meaning, that is, to mean that a given product or process can optionally also have additional features or elements beyond those expressly described.

As used herein, the term “about” means ±10% of the noted value. By way of example only, a composition comprising “about 30 weight percent” of a given component could include from 27 weight percent of the component up to and including 33 weight percent of the component.

The terms “concentrate” and “syrup” are used interchangeably throughout this disclosure and refer to an aqueous sweetener composition suitable for use in beverage preparation.

As used herein, the term “Brix” means the sugar content of an aqueous solution (w/w). By way of example only, a solution that is 1 degree Brix contains 1 g of sucrose in 100 grams of solution, while a solution that is 5 degrees Brix contains 5 g sucrose in 100 g solution.

The term “sweetness perception threshold,” as generally used herein, is the lowest known concentration of a given sweetener or combination of sweeteners that is perceivable by the human sense of taste, typically around about 1.5% sucrose equivalence.

As used herein, “taste” refers to a combination of sweetness perception, temporal effects of sweetness perception, i.e., on-set and duration, off-tastes, e.g. licorice, bitterness and metallic taste, residual perception (aftertaste), and tactile perception, e.g. body and thickness.

The term “nutritive sweetener” refers generally to sweeteners which provide significant caloric content in typical usage amounts, e.g., more than about 5 calories per 8 oz. serving of a beverage including the nutritive sweetener in a typical usage amount.

As used herein, the term “non-nutritive sweetener” refers to all sweeteners other than nutritive sweeteners.

As used herein, “full-calorie” means that a beverage formulation is fully sweetened with a nutritive sweetener.

As used herein, “zero-calorie” means having less than 5 calories per serving, e.g., per 8 oz. for beverages.

As used herein, “reduced calorie” means that a beverage has a reduced number of calories as compared with a full-calorie counterpart; more particularly, “reduced calorie” typically means having at least a 25% reduction in calories per serving, e.g., per 8 oz. for beverages.

As used herein, “low-calorie natural sweetener” refers to a naturally-occurring material which imparts sweetness to a beverage and which has a caloric content of less than 4 cal/g.

As used herein, a “potent sweetener” means a sweetener which is at least twice as sweet as sugar, i.e. a sweetener which on a weight basis requires no more than half the weight of sugar to achieve an equivalent sweetness. For example, a potent sweetener can require less than one-half the weight of sugar to achieve an equivalent sweetness in a beverage sweetened to a level of 10 degrees Brix with sugar. Potent sweeteners include both nutritive (e.g., Lo Han Guo juice concentrate) and non-nutritive sweeteners (e.g., typically, Mogroside V). In addition, potent sweeteners include both natural potent sweeteners (e.g., steviol glycosides, Mogroside V, etc.) and artificial potent sweeteners (e.g., neotame, aspartame, sucralose, acesulfame, etc.). However, for natural beverage products, only natural potent sweeteners are employed.

A percentage of a component used this disclosure refers to a weight percentage unless otherwise specified. As used herein, a weight percentage is calculated based on the total weight of a given composition or formulation.

As used in this disclosure, unless otherwise specified, the term “added,” “combined,” and terms of similar character mean that the multiple ingredients or components referred to (e.g., one or more sweeteners, sweetness enhancers, etc.) are combined in any manner and in any order, with or without stirring.

In certain embodiments, test data was analyzed using a statistical model, for example, Analysis of Variance (ANOVA) and the General Linear Model (GLM) in MINITAB 16. A General Linear Model can be used to determine whether the means of two or more groups differ.

The present disclosure describes beverages with statistically significant differences for certain attributes relative a comparative beverage, for example, a beverage comprising 200 ppm rebaudioside M, 100 ppm rebaudioside A, and 100 pm rebaudioside D. In some embodiments, the confidence level at which the statistically significant differences are observed can be at least 80%, at least 85%, at least 90%, and at least 95%.

Sweetener Compositions

In certain embodiments, the present disclosure provides a sweetener composition. In certain embodiments, the sweetener compositions include a three way blend of rebaudioside A (Reb A), rebaudioside D (Reb D), and rebaudioside M (Reb M). The sweetener compositions can also further include erythritol and/or D-allulose (also known as D-psicose).

Individually, rebaudiosides A, D, and M are known to have “off-notes” such as bitterness, astringency, a licorice-like taste, and sourness, amongst other undesirable flavor characteristics when used on their own, and even when used as a combination of any two of these components. That said, and in certain embodiments, it has now been surprisingly discovered that a three-way blend of rebaudiosides A, D, and M at a weight ratio of about 2:1:1 (A:D:M) can provide a sweetener composition having a flavor profile that reduces or eliminates the off-notes associated with the noted rebaudiosides when used individually or in pairs. It has further been discovered that in certain embodiments, the flavor profile of the present sweetener composition can further be enhanced when rebaudiosides A, D, and M are further combined with erythritol and/or D-allulose.

In certain embodiments of the sweetener composition, the weight ratio of rebaudioside A to rebaudioside D and the weight ratio of rebaudioside A to rebaudioside M can each be, individually, in a range of from 2.2:1 to 1.8:1, from 2.1:1 to 1.8:1, from 2:1 to 1.8:1, from 1.9:1 to 1.8:1, from 2.2:1 to 1.9:1, from 2.1:1 to 1.9:1, from 2:1 to 1.9:1, from 2.2:1 to 2:1, from 2.1:1 to 2:1, or from 2.2:1 to 2.1:1.

In certain embodiments of the sweetener composition, rebaudiosides A and D can be present in a weight ratio of 2.2:1, 2.1:1, 2:1, 1.9:1, or 1.8:1. In particular embodiments, the weight ratio of rebaudioside A to rebaudioside D can be 2:1.

In certain embodiments of the sweetener composition, rebaudioside A and rebaudioside M are present in a weight ratio of 2.2:1, 2.1:1, 2:1, 1.9:1, or 1.8:1. In particular embodiments, the weight ratio of rebaudioside A to rebaudioside M can be 2:1.

In still further embodiments, the sweetener composition can comprise rebaudioside A and rebaudioside D at a weight ratio of 2:1 and rebaudioside A and rebaudioside M and a weight ratio of 2:1.

As noted above, in certain embodiments, the sweetener composition can further include erythritol and/or D-allulose. In certain embodiments, erythritol can be present in an amount such that the weight ratio of rebaudioside A to erythritol can range from about 1:110 to about 1:140 and in particular embodiments, from 1:110 to 1:140, from 1:115 to 1:140, from 1:120 to 1:140, from 1:125 to 1:140, from 1:130 to 1:140, from 1:135 to 1:140, from 1:110 to 1:135, from 1:115 to 1:135, from 1:120 to 1:135, from 1:125 to 1:135, from 1:130 to 1:135, from 1:110 to 1:130, from 1:115 to 1:130, from 1:120 to 1:130, from 1:125 to 1:130, from 1:110 to 1:125, from 1:115 to 1:125, from 1:120 to 1:125, from 1:110 to 1:120, from 1:115 to 1:120, or from 1:110 to 1:115.

In particular embodiments, the weight ratio of rebaudioside A to erythritol can be about 1:110, about 1:115, about 1:120, about 1:125, about 1:130, about 1:135, or about 1:140. In a further embodiment, the weight ratio of rebaudioside A to erythritol can be about 1:125. In yet another embodiment, the weight ratio of rebaudioside A to erythritol can be 1:125.

In certain embodiments of the sweetener composition, D-allulose can be present in an amount such that the weight ratio of rebaudioside A to D-allulose can range from about 1:90 to about 1:120, and in certain embodiments, from 1:90 to 1:120, from 1:95 to 1:120, from 1:100 to 1:120, from 1:105 to 1:120, from 1:110 to 1:120, from 1:115 to 1:120, from 1:90 to 1:115, from 1:95 to 1:115, from 1:100 to 1:115, from 1:105 to 1:115, from 1:110 to 1:115, from 1:90 to 1:110, from 1:95 to 1:110, from 1:100 to 1:110, from 1:105 to 1:110, from 1:90 to 1:105, from 1:95 to 1:105, from 1:100 to 1:105, from 1:90 to 1:100, from 1:95 to 1:100, or from 1:90 to 1:95.

In particular embodiments, the weight ratio of rebaudioside A to D-allulose can be about 1:90, about 1:95, about 1:100, about 1:105, about 1:110, about 1:115, or about 1:120. In a further embodiment, the weight ratio of rebaudioside A to D-allulose can be about 1:105 or, in a further embodiments, 1:105.

In certain embodiments, both erythritol and D-allulose are present in the sweetener composition and can be present in any of the ratios specified above. In further embodiments, both erythritol and D-allulose are included in the sweetener composition and the weight ratio of rebaudioside A to erythritol can be about 1:125 and the weight ratio of rebaudioside A to D-allulose can be about 1:105.

In addition to erythritol and/or D-allulose, in certain embodiments the sweetener composition disclosed herein can further include one or more natural nutritive sweeteners, one or more sugar alcohols other than erythritol, one or more rare sugars other than D-allulose, one or more artificial sweeteners, and/or one or more natural non-nutritive potent sweeteners.

Exemplary natural nutritive sweeteners include, but are not limited to, crystalline or liquid sucrose, fructose, glucose, dextrose, maltose, trehalose, fructo-oligosaccharides, glucose-fructose syrup from natural sources such as apple, chicory, and honey; high fructose corn syrup, invert sugar, maple syrup, maple sugar, honey, brown sugar molasses, cane molasses, such as first molasses, second molasses, blackstrap molasses, and sugar beet molasses; sorghum syrup, and mixtures thereof.

Exemplary sugar alcohols include, but are not limited to, sorbitol, mannitol, xylitol, lactitol, isomalt, malitol, tagatose, trehalose, galactose, rhamnose, cyclodextrin, ribulose, threose, arabinose, xylose, lyxose, allose, altrose, mannose, idose, lactose, maltose, isotrehalose, neotrehalose, palatinose or isomaltulose, erythrose, deoxyribose, gulose, talose, erythrulose, xylulose, allulose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffinose, rhamnose, ribose, and mixtures thereof.

Suitable rare sugars include, but are not limited to, D-allose, L-ribose, D-tagatose, L-glucose, L-fucose, L-arabinose, D-turanose, D-leucrose, and mixtures thereof.

Suitable artificial sweeteners include, but are not limited to, saccharin, cyclamate, aspartame, neotame, advantame, acesulfame potassium, sucralose, mixtures thereof.

Exemplary natural non-nutritive potent sweeteners suitable for use in the sweetener composition disclosed here include, but are not limited to, other steviol glycosides (e.g., stevioside, steviolbioside, rebaudioside B, rebaudioside C, rebaudioside E, rebaudioside F, rebaudioside H, rebaudioside I, rebaudioside N, rebaudioside K, rebaudioside J, rebaudioside O, dulcoside A, rubusoside, iso-steviol glycosides such as iso-rebaudioside A, and mixtures thereof), Lo Han Guo powder, neohesperidin dihydrochalcone, trilobatin, glycyrrhizin, phyllodulcin, hernandulcin, osladin, polypodoside A, baiyunoside, pterocaryoside, thaumatin, monellin, monatin, mabinlins I and II, and mixtures thereof.

In certain embodiments, any of the noted natural nutritive sweeteners, artificial sweeteners, and/or natural non-nutritive potent sweeteners can be used as a sweetener, i.e., at a concentration above a given components sweetness perception threshold. In other embodiments, however, any of the foregoing can be used as a sweetness enhancer or masking agent. In these embodiments, a given component is used in an amount below its sweetness perception threshold.

The sweetener composition, whether a dry blend or in liquid form, can be utilized in any food or beverage product typically including a sweetener, including, but not limited to, those uses discussed throughout this disclosure. In addition to those uses specified elsewhere herein, the sweetener composition described herein is also suitable for use in cooking, baking (i.e. for use in cookies, cakes, pies, brownies, breads, granola bars, etc.), for preparing sweetened toppings, such as icings, and for use in jellies, jams, preserves, oat-based products (e.g. instant oatmeal products), and the like. It is similarly suitable for use in frozen dairy products, such as ice cream, as well as in whipped toppings. Although in certain embodiments, the sweetener composition can be dissolved in the food or beverage, in other embodiments, the sweetener composition can be present in the food or beverage as part of a suspension or emulsion.

### Beverage Compositions

In addition to the above-described sweetener composition, the present disclosure also provides a beverage comprising a blend of rebaudiosides A, D, and M. The beverage can also further include erythritol and/or D-allulose. In certain embodiments, the beverage is a zero- or reduced-calorie beverage.

In certain embodiments, the beverage contains rebaudiosides A, D, and M at a ratio of about 2:1:1 (A:D:M). In certain embodiments, the beverage can further include erythritol in a concentration of about 2.5% by weight of the beverage, and/or D-allulose in a concentration of about 2.1% by weight of the beverage.

In certain embodiments of the beverage, the weight ratio of rebaudioside A to rebaudioside D and the weight ratios of rebaudioside A to rebaudioside M can each be, individually, in a range of from 2.2:1 to 1.8:1, from 2.1:1 to 1.8:1, from 2:1 to 1.8:1, from 1.9:1 to 1.8:1, from 2.2:1 to 1.9:1, from 2.1:1 to 1.9:1, from 2:1 to 1.9:1, from 2.2:1 to 2:1, from 2.1:1 to 2:1, or from 2.2:1 to 2.1:1.

In certain embodiments of the beverage, rebaudioside A and rebaudioside D can be present in a weight ratio of 2.2:1, 2.1:1, 2:1, 1.9:1, or 1.8:1. In particular embodiments, the weight ratio of rebaudioside A to rebaudioside D can be about 2:1 or, in a further embodiments, 2:1.

In certain embodiments of the beverage, rebaudioside A and rebaudioside M can be present in a weight ratio of 2.2:1, 2.1:1, 2:1, 1.9:1, or 1.8:1. In particular embodiments, the weight ratio of rebaudioside A to rebaudioside M can be about 2:1 or, in a further embodiment, 2:1.

In certain embodiments of the beverage, the beverage can further include erythritol and/or D-allulose. In certain embodiments, erythritol can be present in an amount such that the weight ratio of rebaudioside A to erythritol can range from about 1:110 to about 1:140 and in particular embodiments, from 1:110 to 1:140, from 1:115 to 1:140, from 1:120 to 1:140, from 1:125 to 1:140, from 1:130 to 1:140, from 1:135 to 1:140, from 1:110 to 1:135, from 1:115 to 1:135, from 1:120 to 1:135, from 1:125 to 1:135, from 1:130 to 1:135, from 1:110 to 1:130, from 1:115 to 1:130, from 1:120 to 1:130, from 1:125 to 1:130, from 1:110 to 1:125, from 1:115 to 1:125, from 1:120 to 1:125, from 1:110 to 1:120, from 1:115 to 1:120, or from 1:110 to 1:115.

In particular embodiments, rebaudioside A and erythritol can be present in a weight ratio of about 1:110, about 1:115, about 1:120, about 1:125, about 1:130, about 1:135, or about 1:140. In a further embodiment, the weight ratio of rebaudioside A to erythritol can be about 1:125. In yet another embodiment, the weight ratio of rebaudioside A to erythritol can be 1:125.

In certain embodiments of the beverage, D-allulose can be present in an amount such that the weight ratio of rebaudioside A to D-allulose can range from about 1:90 to about 1:120, and in certain embodiments, from 1:90 to 1:120, from 1:95 to 1:120, from 1:100 to 1:120, from 1:105 to 1:120, from 1:110 to 1:120, from 1:115 to 1:120, from 1:90 to 1:115, from 1:95 to 1:115, from 1:100 to 1:115, from 1:105 to 1:115, from 1:110 to 1:115, from 1:90 to 1:110, from 1:95 to 1:110, from 1:100 to 1:110, from 1:105 to 1:110, from 1:90 to 1:105, from 1:95 to 1:105, from 1:100 to 1:105, from 1:90 to 1:100, from 1:95 to 1:100, or from 1:90 to 1:95.

In particular embodiments, rebaudioside A and D-allulose can be present in a weight ratio of about 1:90, about 1:95, about 1:100, about 1:105, about 1:110, about 1:115, or about 1:120. In a further embodiment, the weight ratio of rebaudioside A to D-allulose can be about 1:105 or, in a further embodiments, 1:105.

In certain embodiments, both erythritol and D-allulose are present in the beverage and can be present in any of the ratios specified above. In further embodiments, both erythritol and D-allulose are included in the beverage and the weight ratio of rebaudioside A to erythritol can be about 1:125 and the weight ratio of rebaudioside A to D-allulose can be about 1:105.

In certain embodiments, and within the various ratios noted above, rebaudioside A can be present in the beverage in a concentration of from about 100 ppm to about 360 ppm, from 150 ppm to 360 ppm, from 175 ppm to 360 ppm, from 200 ppm to 360 ppm, from 225 ppm to 360 ppm, from 250 ppm to 360 ppm, from 300 ppm to 360 ppm, from 100 ppm to 300 ppm, from 150 ppm to 300 ppm, from 175 ppm to 300 ppm, from 200 ppm to 300 ppm, from 225 ppm to 300 ppm, from 250 ppm to 300 ppm, from 100 ppm to 250 ppm, from 150 ppm to 250 ppm, from 175 ppm to 250 ppm, from 200 ppm to 250 ppm, from 225 ppm to 250 ppm, from 100 ppm to 225 ppm, from 150 ppm to 225 ppm, from 175 ppm to 225 ppm, from 200 ppm to 225 ppm, from 100 ppm to 200 ppm, from 150 ppm to 200 ppm, from 175 ppm to 200 ppm, from 100 ppm to 175 ppm, from 150 ppm to 175 ppm, or from 100 ppm to 150 ppm. In certain embodiments, rebaudioside A can be present in the beverage in a concentration of from 180 ppm to 220 ppm, from 190 ppm to 210 ppm, or from 195 ppm to 205 ppm.

In particular embodiments, rebaudioside A can be present in the beverage in a concentration of about 100 ppm, about 125 ppm, about 150 ppm, about 175 ppm, about 200 ppm, about 225 ppm, about 250 ppm, about 275 ppm, about 300 ppm, or about 360 ppm. In a particular embodiment, rebaudioside A can be present in the beverage in a concentration of about 200 ppm, and in certain embodiments 200 ppm.

In certain embodiments, rebaudioside D can be present in the beverage in a concentration of from 50 to 180 ppm, from 80 to 180 ppm, from 90 to 180 ppm, from 100 to 180 ppm, from 110 to 180 ppm, from 120 to 180 ppm, from 150 to 180 ppm, from 50 to 150 ppm, from 80 to 150 ppm, from 90 to 150 ppm, from 100 to 150 ppm, from 110 to 150 ppm, from 120 to 150 ppm, from 50 to 120 ppm, from 80 to 120 ppm, from 90 to 120 ppm, from 100 to 120 ppm, from 110 to 120 ppm, from 50 to 110 ppm, from 80 to 110 ppm, from 90 to 110 ppm, from 100 to 110 ppm, from 50 to 100 ppm, from 80 to 100 ppm, from 90 to 100 ppm, from 50 to 90 ppm, from 80 to 90 ppm, or from 50 to 80 ppm. In certain embodiments, rebaudioside D can be present in the beverage in a concentration of from 80 ppm to 120 ppm, from 90 ppm to 110 ppm, or from 95 ppm to 105 ppm.

In particular embodiments, rebaudioside D can be present in the beverage in a concentration of about 50 ppm, about 60 ppm, about 70 ppm, about 80 ppm, about 90 ppm, about 100 ppm, about 110 ppm, about 120 ppm, about 130 ppm, about 140 ppm, about 150 ppm, about 160 ppm, about 170 ppm, or about 180 ppm. In a further embodiment, rebaudioside D can be present in the beverage in a concentration of about 100 ppm, or in a particular embodiments, 100 ppm.

In certain embodiments, rebaudioside M can be present in the beverage in a concentration of from 50 to 180 ppm, from 80 to 180 ppm, from 90 to 180 ppm, from 100 to 180 ppm, from 110 to 180 ppm, from 120 to 180 ppm, from 150 to 180 ppm, from 50 to 150 ppm, from 80 to 150 ppm, from 90 to 150 ppm, from 100 to 150 ppm, from 110 to 150 ppm, from 120 to 150 ppm, from 50 to 120 ppm, from 80 to 120 ppm, from 90 to 120 ppm, from 100 to 120 ppm, from 110 to 120 ppm, from 50 to 110 ppm, from 80 to 110 ppm, from 90 to 110 ppm, from 100 to 110 ppm, from 50 to 100 ppm, from 80 to 100 ppm, from 90 to 100 ppm, from 50 to 90 ppm, from 80 to 90 ppm, or from 50 to 80 ppm. In certain embodiments, rebaudioside M can be present in the beverage in a concentration of from 80 ppm to 120 ppm, from 90 ppm to 110 ppm, or from 95 ppm to 105 ppm.

In particular embodiments, rebaudioside M can be present in the beverage in a concentration of about 50 ppm, about 60 ppm, about 70 ppm, about 80 ppm, about 90 ppm, about 100 ppm, about 110 ppm, about 120 ppm, about 130 ppm, about 140 ppm, about 150 ppm, about 160 ppm, about 170 ppm, or about 180 ppm. In a particular embodiment, rebaudioside M can be present in the beverage in a concentration of about 100 ppm, and in particular embodiments, 100 ppm.

In certain embodiments, erythritol can be present in the beverage in a concentration of from 2% to 3%, from 2.1% to 3%, from 2.2% to 3%, from 2.3% to 3%, from 2.4% to 3%, from 2.5% to 3%, from 2.6% to 3%, from 2.7% to 3%, from 2.8% to 3%, from 2.9% to 3%, from 2% to 2.8%, from 2.1% to 2.8%, from 2.2% to 2.8%, from 2.3% to 2.8%, from 2.4% to 2.8%, from 2.5% to 2.8%, from 2.6% to 2.8%, from 2.7% to 2.8%, from 2% to 2.6%, from 2.1% to 2.6%, from 2.2% to 2.6%, from 2.3% to 2.6%, from 2.4% to 2.6%, from 2.5% to 2.6%, from 2% to 2.4%, from 2.1% to 2.4%, from 2.2% to 2.4%, from 2.3% to 2.4%, from 2% to 2.2%, or from 2.1% to 2.2%.

In certain embodiments, erythritol can be present in the beverage in a concentration of about 2%, about 2.1%, about 2.2%, about 2.3%, about 2.4%, about 2.5%, about 2.6%, about 2.7%, about 2.8%, about 2.9%, or about 3%. In particular embodiments, the erythritol can be present in a concentration of about 2.5% by weight of the beverage.

In certain embodiments, D-allulose can be present in the beverage in a concentration of from 1.6% to 2.6%, from 1.7% to 2.6%, from 1.8% to 2.6%, from 1.9% to 2.6%, from 2% to 2.6%, from 2.1% to 2.6%, from 2.2% to 2.6%, from 2.3% to 2.6%, from 2.4% to 2.6%, from 2.5% to 2.6%, 1.6% to 2.4%, from 1.7% to 2.4%, from 1.8% to 2.4%, from 1.9% to 2.4%, from 2% to 2.4%, from 2.1% to 2.4%, from 2.2% to 2.4%, from 2.3% to 2.4%, 1.6% to 2.2%, from 1.7% to 2.2%, from 1.8% to 2.2%, from 1.9% to 2.2%, from 2% to 2.2%, from 2.1% to 2.2%, 1.6% to 2%, from 1.7% to 2%, from 1.8% to 2%, from 1.9% to 2%, from 1.6% to 1.8%, or from 1.7% to 1.8%.

In certain embodiments, D-allulose can be present in the beverage in a concentration of about 1.6%, about 1.7%, about 1.8%, about 1.9%, about 2%, about 2.1%, about 2.2%, about 2.3%, about 2.4%, about 2.5%, or about 2.6%. In particular embodiments, the D-allulose can be present in a concentration of about 2.1% by weight of the beverage.

In certain embodiments, a beverage as described herein can contain, for example, about 100 ppm of rebaudioside A and about 50 ppm each of rebaudiosides D and M. In other embodiments, the beverage can contain about 120 ppm of rebaudioside A and about 60 ppm each of rebaudiosides D and M, about 130 ppm of rebaudioside A and about 65 ppm each of rebaudiosides D and M, about 140 ppm of rebaudioside A and about 70 ppm each of rebaudiosides D and M, about 150 ppm of rebaudioside A and about 75 ppm each of rebaudiosides D and M, about 160 ppm of rebaudioside A and about 80 ppm each of rebaudiosides D and M, about 170 ppm of rebaudioside A and about 85 ppm each of rebaudiosides D and M, about 180 ppm of rebaudioside A and about 90 ppm each of rebaudiosides D and M, about 190 ppm of rebaudioside A and about 95 ppm each of rebaudiosides D and M, about 200 ppm of rebaudioside A and about 100 ppm each of rebaudiosides D and M, about 210 ppm of rebaudioside A and about 105 ppm each of rebaudiosides D and M, about 220 ppm of rebaudioside A and about 110 ppm each of rebaudiosides D and M, about 230 ppm of rebaudioside A and about 115 ppm each of rebaudiosides D and M, about 240 ppm of rebaudioside A and about 120 ppm each of rebaudiosides D and M, about 250 ppm of rebaudioside A and about 125 ppm each of rebaudiosides D and M, about 260 ppm of rebaudioside A and about 130 ppm each of rebaudiosides D and M. about 270 ppm of rebaudioside A and about 135 ppm each of rebaudiosides D and M, about 280 ppm of rebaudioside A and about 140 ppm each of rebaudiosides D and M, about 290 ppm of rebaudioside A and about 145 ppm each of rebaudiosides D and M, about 300 ppm of rebaudioside A and about 150 ppm each of rebaudiosides D and M, about 310 ppm of rebaudioside A and about 155 ppm each of rebaudiosides D and M, about 320 ppm of rebaudioside A and about 160 ppm each of rebaudiosides D and M, about 330 ppm of rebaudioside A and about 165 ppm each of rebaudiosides D and M, about 340 ppm of rebaudioside A and about 170 ppm each of rebaudiosides D and M, or about 350 ppm of rebaudioside A and about 175 ppm each of rebaudiosides D and M. In a particular embodiments, the beverage can comprise about 200 ppm rebaudioside A and about 100 ppm each of rebaudiosides D and M.

Any of the foregoing beverages can likewise include erythritol and D-allulose at about 2.5 and about 2.1 weight percent, respectively.

In some embodiments, the present disclosure provides a beverage comprising water, an acid, rebaudioside A, rebaudioside D, rebaudioside M, erythritol, and D-allulose, wherein rebaudioside A is present in the beverage in a concentration ranging from about 100 ppm to about 300 ppm and wherein each of rebaudiosides D and M is present in the beverage in a concentration ranging from about 50 ppm to about 150 ppm; further wherein: a ratio of the concentrations of rebaudioside A to rebaudioside D is about 2:1; a ratio of the concentrations of rebaudioside A to rebaudioside M is about 2:1; D-allulose is present in a sweetening amount, but not more than about 2.1 weight percent; and erythritol is present in a sweetening amount, but not more than about 2.5 weight percent.

In some embodiments, the concentration of rebaudioside A is about 100 ppm. In some embodiments, the concentration of rebaudioside A is about 200 ppm.

In some embodiments, the beverage disclosed herein exhibits a statistically significant reduction in sourness relative to a comparative beverage comprising 200 ppm rebaudioside M, 100 ppm rebaudioside A, and 100 pm rebaudioside D.

In some embodiments, the beverage exhibits a statistically significant increase in sweetness relative to a comparative beverage comprising 200 ppm rebaudioside M, 100 ppm rebaudioside A, and 100 pm rebaudioside D.

In some embodiments, the beverage exhibits a statistically significant increase in speed of sweetness onset relative to a comparative beverage comprising 200 ppm rebaudioside M, 100 ppm rebaudioside A, and 100 pm rebaudioside D.

In some embodiments, the beverage exhibits a statistically significant reduction in total aftertaste relative to a comparative beverage comprising 200 ppm rebaudioside M, 100 ppm rebaudioside A, and 100 pm rebaudioside D.

In some embodiments, the beverage exhibits a statistically significant increase in sweet aromatics relative to a comparative beverage comprising 200 ppm rebaudioside M, 100 ppm rebaudioside A, and 100 pm rebaudioside D.

In some embodiments, the beverage exhibits a statistically significant increase of sweetness in sweet adaption at about 10 seconds relative to a comparative beverage comprising 200 ppm rebaudioside M, 100 ppm rebaudioside A, and 100 pm rebaudioside D.

In some embodiments, the beverage exhibits a statistically significant reduction of bitterness in bitter sensitization at about 180 seconds relative to a comparative beverage comprising 200 ppm rebaudioside M, 100 ppm rebaudioside A, and 100 pm rebaudioside D.

In some embodiments, the statistical significance observed for the characteristics of the beverage disclosed herein is observed at at least an 80% confidence level, at least an 85% confidence level, or at least an 90% confidence level. The confidence level can be obtained from statistical analysis using Analysis of Variance (ANOVA) and the General Linear Model (GLM) in MINITAB 16, as described in the examples of the present disclosure.

In certain embodiments, the present disclosure also provides a beverage syrup comprising water, an acid, rebaudioside A, rebaudioside D, rebaudioside M, erythritol, and D-allulose, wherein rebaudioside A is present in the beverage in a concentration ranging from about 600 ppm to about 1200 ppm and wherein each of rebaudiosides D and M is present in the syrup in a concentration ranging from about 300 ppm to about 600 ppm; further wherein: a ratio of the concentrations of rebaudioside A to rebaudioside D is about 2:1; a ratio of the concentrations of rebaudioside A to rebaudioside M is about 2:1; D-allulose is present in an amount of at least 6.3 weight percent , but not more than about 12.6 weight percent; and erythritol is present in an amount of at least 7.5 weight percent, but not more than about 15 weight percent.

The present disclosure further provides a sweetener composition comprising rebaudioside A, rebaudioside D, rebaudioside M, erythritol, and D-allulose, wherein: a weight ratio of rebaudioside A to rebaudioside D is about 2:1; a weight ratio of rebaudioside A to rebaudioside M is about 2:1; a weight ratio of rebaudioside A to D-allulose is about 1:90 to about 1:120; and a weight ratio of rebaudioside A to erythritol is from about 1:110 to about 1:140.

In some embodiments, the weight ratio of rebaudioside A to erythritol is about 1:125. In some embodiments, the weight ratio of rebaudioside A to D-allulose is about 1:105.

In certain embodiments, the beverage comprising the blend of rebaudiosides A, D, and M can be a carbonated or non-carbonated beverage including, for example, a soft drink, a fountain beverage, a frozen ready-to-drink beverage (carbonated or non-carbonated), a coffee beverage, a tea beverage, a brewed beverage other than coffee or tea, a dairy beverage, a flavored water, an enhanced water, a juice such as a fruit juice (including diluted and ready to drink concentrated juices), a fruit juice-flavored drink, a sport drink, a smoothie, a functionally enhanced beverage such as a caffeinated energy drink, or an alcoholic product. In particular embodiments, the beverage composition can be a carbonated beverage, such as a carbonated cola-flavored beverage. Cola-flavored carbonated beverages characteristically contain, in addition to the combination of rebaudiosides disclosed herein, carbonated water, sweetener, kola nut extract and/or other flavorings, caramel coloring, phosphoric acid, and optionally other ingredients.

In other embodiments, the beverage comprising the mixture of rebaudiosides disclosed herein can be water beverage. In still further embodiments, the beverage comprising the mixture of rebaudiosides disclosed herein can be a tea or coffee beverage. In yet another embodiment, the beverage comprising the mixture of rebaudiosides disclosed herein can be a juice.

The beverages comprising the rebaudioside blends disclosed herein can also include any of the additional ingredients disclosed herein.

### Beverage Concentrate Compositions

Beverages are typically not prepared in large batches. Instead, a concentrate or syrup, water, and optionally carbon dioxide are combined at the time of use or at the time of bottling or dispensing a beverage. The syrup is a concentrated solution of many of the soluble ingredients typically included in a given beverage.

Thus, in certain embodiments, the present disclosure provides a beverage concentrate. In certain embodiments, the beverage concentrate can be prepared with an initial volume of water and rebaudiosides A, D, and M in a ratio of about 2:1:1, but at a concentration which will provide the desired final concentration of the sweeteners for a given beverage.

For example, in certain embodiments, full strength beverages can be formed from the beverage concentrate by adding further volumes of water to the concentrate. In certain embodiments, a full strength beverage can be prepared from a concentrate by combining about 1 part concentrate with about 3 to about 7 parts water. In certain embodiments, the full strength beverage can be prepared by combining 1 part concentrate with 5 parts water. In certain exemplary embodiments the water added to the concentrate to form the full strength beverages can be carbonated.

Thus, and by way of example only, if the desired concentrations of rebaudiosides A, D, and M in a final beverage are about 200 ppm, 100 ppm, and 100 ppm, respectively, and the final beverage is going to be prepared in a “5+1 throw,” the concentrate can contain about 1200 ppm rebaudioside A and about 600 ppm each of rebaudiosides D and M.

In certain embodiments, the syrup can also contain up to about 18 weight percent each of D-allulose and/or erythritol. In other embodiments, D-allulose and/or erythritol can be present in an amount of from about 3 to about 15 weight percent each. In certain embodiments, D-allulose can be present in the concentrate at about 12.6 weight percent and erythritol can be present in the concentrate at about 15 weight percent.

### Additional Ingredients

The beverage and concentrate compositions described herein can have any of numerous different specific formulations or constitutions and can vary depending upon such factors as the product's intended market segment, its desired nutritional characteristics, flavor profile, and the like. For example, additional ingredients can be added to the formulation of a particular beverage or concentrate embodiment. Additional ingredients include, but are not limited to, one or more additional sweeteners (in addition to any sweetener already present), flavorings, colorants, preservatives, buffering salts, electrolytes, vitamins, fruit juices or other fruit products, tastants, masking agents, flavor enhancers, food grade acids, carbonation, or any combination of the foregoing. These can be added to any of the beverage or concentrate compositions described herein to vary the taste, mouthfeel, and/or nutritional characteristics of the compositions.

In certain embodiments, the compositions disclosed herein can contain a flavor composition, for example, natural, nature identical, and/or synthetic fruit flavors, botanical flavors, other flavors, and mixtures thereof. As used here, the term “fruit flavor” refers generally to those flavors derived from the edible reproductive part of a seed plant including those plants wherein a sweet pulp is associated with the seed, e.g., tomato, cranberry, and the like, and those having a small, fleshy berry. The term berry includes true berries as well as aggregate fruits, i.e., not “true” berries, but fruit commonly accepted as such. Also included within the term “fruit flavor” are synthetically prepared flavors made to simulate fruit flavors derived from natural sources. Examples of suitable fruit or berry sources include whole berries or portions thereof, berry juice, berry juice concentrates, berry purees and blends thereof, dried berry powders, dried berry juice powders, and the like.

Exemplary fruit flavors include the citrus flavors, e.g., orange, lemon, lime grapefruit, tangerine, mandarin orange, tangelo, and pomelo, apple, grape, cherry, and pineapple flavors. In certain embodiments beverages comprise a fruit flavor component, e.g., a juice concentrate or juice. As used here, the term “botanical flavor” refers to flavors derived from parts of a plant other than the fruit. As such, botanical flavors can include those flavors derived from essential oils and extracts of nuts, bark, roots, and leaves. Also included within the term “botanical flavor” are synthetically prepared flavors made to simulate botanical flavors derived from natural sources. Examples of such flavors include cola flavors, tea flavors, and mixtures thereof. The flavor component can further comprise a blend of several of the above-mentioned flavors. In certain exemplary embodiments of the beverages a cola flavor component is used or a tea flavor component. The particular amount of the flavor component useful for imparting flavor characteristics to the beverages of the present disclosure will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

Juices suitable for use in at least certain exemplary embodiments of the compositions disclosed here include, e.g., fruit, vegetable and berry juices. Juices can be employed in the present compositions in the form of a concentrate, puree, single-strength juice, or other suitable forms. The term “juice” as used here includes single-strength fruit, berry, or vegetable juice, as well as concentrates, purees, milks, and other forms. Multiple different fruit, vegetable and/or berry juices can be combined, optionally along with other flavorings, to generate a concentrate, beverage, or solid food having a desired flavor. Examples of suitable juice sources include plum, prune, date, currant, fig, grape, raisin, cranberry, pineapple, peach, banana, apple, pear, guava, apricot, Saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, sloe, rowan, gooseberry, pomegranate, persimmon, mango, rhubarb, papaya, litchi, lemon, orange, lime, tangerine, mandarin, melon, watermelon, and grapefruit. Numerous additional and alternative juices suitable for use in at least certain exemplary embodiments will be apparent to those skilled in the art given the benefit of this disclosure. In the compositions of the present disclosure employing juice, juice can be used, for example, at a level of at least about 0.2 weight percent of the composition. In certain embodiments juice can be employed at a level of from about 0.2 weight percent to about 40 weight percent. In further embodiments, juice can be used, if at all, in an amounts ranging from about 1 to about 20 weight percent.

Juices that are lighter in color can be included in the formulation of certain exemplary embodiments to adjust the flavor and/or increase the juice content of the beverage without darkening the beverage color. Examples of such juices include apple, pear, pineapple, peach, lemon, lime, orange, apricot, grapefruit, tangerine, rhubarb, cassis, quince, passion fruit, papaya, mango, guava, litchi, kiwi, mandarin, coconut, and banana. Deflavored and decolored juices can be employed if desired.

Other flavorings suitable for use in at least certain exemplary embodiments of the compositions disclosed here include, for example, spice flavorings, such as cassia, clove, cinnamon, pepper, ginger, vanilla spice flavorings, cardamom, coriander, root beer, sassafras, ginseng, and others. Numerous additional and alternative flavorings suitable for use in at least certain exemplary embodiments will be apparent to those skilled in the art given the benefit of this disclosure. Flavorings can be in the form of an extract, oleoresin, juice concentrate, bottler's base, or other forms known in the art. In at least certain exemplary embodiments, such spice or other flavors complement that of a juice or juice combination. In other embodiments, the spice or other flavors complement that of a cola beverage.

In certain embodiments, the one or more flavorings can be used in the form of an emulsion. A flavoring emulsion can be prepared by mixing some or all of the flavorings together, optionally together with other ingredients of the composition, and an emulsifying agent. The emulsifying agent can be added with or after the flavorings mixed together. In certain exemplary embodiments the emulsifying agent is water-soluble. Exemplary suitable emulsifying agents include gum acacia, modified starch, carboxymethylcellulose, gum tragacanth, gum ghatti and other suitable gums. Additional suitable emulsifying agents will be apparent to those skilled in the art of beverage formulations, given the benefit of this disclosure. The emulsifier in exemplary embodiments comprises greater than about 3% of the mixture of flavorings and emulsifier. In certain exemplary embodiments the emulsifier is from about 5% to about 30% of the mixture.

Carbon dioxide can be used to provide effervescence to certain exemplary embodiments of the beverages disclosed here. Any of the techniques and carbonating equipment known in the art for carbonating beverages can be employed. Carbon dioxide can enhance beverage taste and appearance and can aid in safeguarding the beverage purity by inhibiting and/or destroying objectionable bacteria. In certain embodiments, for example, the beverage can have a CO₂ level up to about 4.0 volumes carbon dioxide. Other embodiments can have, for example, from about 0.5 to about 5.0 volumes of carbon dioxide. As used herein, one volume of carbon dioxide refers to the amount of carbon dioxide absorbed by a given quantity of a given liquid, such as water, at 60° F. (16° C.) and one atmospheric pressure. A volume of gas occupies the same space as does the liquid by which it is dissolved. The carbon dioxide content can be selected by those skilled in the art based on the desired level of effervescence and the impact of the carbon dioxide on the taste or mouthfeel of the beverage.

In certain embodiments, caffeine can be added to any of the compositions described herein. The amount of caffeine added can be determined by the desired properties of a given beverage or concentrate and any applicable regulatory provisions of the country where the concentrate or its resulting beverage is marketed. In certain embodiments caffeine can be included in an amount sufficient to provide a final beverage product having less than about 0.02 weight percent caffeine. The caffeine must be of purity acceptable for use in foods and beverages. The caffeine can be natural or synthetic in origin.

The compositions disclosed here can contain other additional ingredients, including, generally, any of those typically found in beverage formulations. Examples of such other additional ingredients include, but are not limited to, caramel and other coloring agents or dyes, foaming or antifoaming agents, gums, emulsifiers, tea solids, cloud components, and mineral and non-mineral nutritional supplements. Examples of non-mineral nutritional supplement ingredients are known to those of ordinary skill in the art and include, for example, antioxidants and vitamins, including Vitamins A, D, E (tocopherol), C (ascorbic acid), B (thiamine), B2 (riboflavin), B6, B12, K, niacin, folic acid, biotin, and combinations thereof. The optional non-mineral nutritional supplements are typically present in amounts generally accepted under good manufacturing practices. Exemplary amounts can be between about 1% and about 100% Recommended Daily Value (RDV), where such RDVs are established. In certain exemplary embodiments the non-mineral nutritional supplement ingredient(s) can be present in an amount of from about 5% to about 20% RDV, where established.

Preservatives can be used in at least certain embodiments of the compositions disclosed here. That is, at least certain exemplary embodiments can contain an optional dissolved preservative system. Solutions with a pH below 4 and especially those below 3 typically are “micro-stable,” i.e., they resist growth of microorganisms, and so are suitable for longer term storage prior to consumption without the need for further preservatives. However, an additional preservative system can be used if desired. If a preservative system is used, it can be added to the composition at any suitable time during production, e.g., in some cases prior to the addition of the sweetener composition. As used here, the terms “preservation system” or “preservatives” include all suitable preservatives approved for use in beverage compositions, including, without limitation, such known chemical preservatives as benzoates, e.g., sodium, calcium, and potassium benzoate, sorbates, e.g., sodium, calcium, and potassium sorbate, citrates, e.g., sodium citrate and potassium citrate, polyphosphates, e.g., sodium hexametaphosphate (SHMP), and mixtures thereof, and antioxidants such as ascorbic acid, EDTA, BHA, BHT, TBHQ, dehydroacetic acid, dimethyldicarbonate, ethoxyquin, heptylparaben, and combinations thereof. Preservatives can be used in amounts not exceeding mandated maximum levels under applicable laws and regulations.

In the case of beverages in particular, the level of preservative used can be adjusted according to the planned final product pH and/or the microbiological spoilage potential of the particular beverage formulation. The maximum level employed typically is about 0.05 weight percent of the beverage. It will be within the ability of those skilled in the art, given the benefit of this disclosure, to select a suitable preservative or combination of preservatives for beverages according to this disclosure.

Other methods of preservation suitable for at least certain exemplary embodiments of the products disclosed here include, e.g., aseptic packaging and/or heat treatment or thermal processing steps, such as hot filling and tunnel pasteurization. Such steps can be used to reduce yeast, mold and microbial growth in the beverage products. For example, U.S. Pat. No. 4,830,862 discloses the use of pasteurization in the production of fruit juice beverages as well as the use of suitable preservatives in carbonated beverages. U.S. Pat. No. 4,925,686 discloses a heat-pasteurized freezable fruit juice composition which contains sodium benzoate and potassium sorbate. Both of these patents are incorporated by reference in their entireties. In general, heat treatment includes hot fill methods typically using high temperatures for a short time, e.g., about 190° F. for 10 seconds, tunnel pasteurization methods typically using lower temperatures for a longer time, e.g., about 160° F. for 10-15 minutes, and retort methods typically using, e.g., about 250° F. for 3-5 minutes at elevated pressure, i.e., at pressure above 1 atmosphere.

Suitable antioxidants can be selected from the group consisting of rutin, quercetin, flavonones, flavones, dihydroflavonols, flavonols, flavandiols, leucoanthocyanidins, flavonol glycosides, flavonone glycosides, isoflavonoids, and neoflavonoids. In particular, the flavonoids can be, but not limited to, quercetin, eriocitrin, neoeriocitrin, narirutin, naringin, hesperidin, hesperetin, neohesperidin, neoponcirin, poncirin, rutin, isorhoifolin, rhoifolin, diosmin, neodiosmin, sinensetin, nobiletin, tangeritin, catechin, catechin gallate, epigallocatechin, epigallocatechin gallate, oolong tea polymerized polyphenol, anthocyanin, heptamethoxyflavone, daidzin, daidzein, biochaminn A, prunetin, genistin, glycitein, glycitin, genistein, 6,7,4′ trihydroxy isoflavone, morin, apigenin, vitexin, balcalein, apiin, cupressuflavone, datiscetin, diosmetin, fisetin, galangin, gossypetin, geraldol, hinokiflavone, primuletin, pratol, luteolin, myricetin, orientin, robinetin, quercetagetin, and hydroxy-4-flavone.

Suitable food grade acids that can be used in the present compositions include water soluble organic acids and their salts. These food grade acids include, for example, phosphoric acid, sorbic acid, ascorbic acid, benzoic acid, citric acid, tartaric acid, propionic acid, butyric acid, acetic acid, succinic acid, glutaric acid, maleic acid, malic acid, valeric acid, caproic acid, malonic acid, aconitic acid, potassium sorbate, sodium benzoate, sodium citrate, amino acids, and combinations of any of them. Such acids are suitable for adjusting the pH of the beverage.

Suitable food grade bases are sodium hydroxide, potassium hydroxide, and calcium hydroxide. Such bases also are suitable for adjusting the pH of a beverage.

### Water

Water is a basic ingredient in the compositions described herein, typically being the vehicle or primary liquid portion in which the remaining ingredients are dissolved, emulsified, suspended, or dispersed. Purified water can be used in the manufacture of certain embodiments of the beverages disclosed here, and water of a standard beverage quality can be employed in order not to adversely affect beverage taste, odor, or appearance. The water typically will be clear, colorless, free from objectionable minerals, tastes and odors, free from organic matter, low in alkalinity and of acceptable microbiological quality based on industry and government standards applicable at the time of producing the beverage.

In certain embodiments, water can be present at a level of from about 20 weight percent to about 99.9 weight percent in the beverage compositions disclosed herein. In certain beverage embodiments, the quantity of water can range from about 80 weight percent to about 99.9 weight percent of the beverage. In at least certain exemplary embodiments the water used in beverages disclosed here is “treated water,” which refers to water that has been treated to reduce the total dissolved solids of the water prior to optional supplementation with calcium as disclosed in U.S. Pat. No. 7,052,725, which is incorporated by reference in its entirety.

Methods of producing treated water are known to those of ordinary skill in the art and include deionization, distillation, filtration and reverse osmosis (“r-o”), among others. The terms “treated water,” “purified water,” “demineralized water,” “distilled water,” and “r-o water” are understood to be generally synonymous in this discussion, referring to water from which substantially all mineral content has been removed, typically containing no more than about 500 ppm total dissolved solids, e.g. 250 ppm total dissolved solids.

### Natural Embodiments

Certain embodiments of the described compositions can be “natural” in that they do not contain anything artificial or synthetic (including any color additives regardless of source) that would not normally be expected to be in the composition. As used herein, therefore, a “natural” composition is defined in accordance with the following guidelines: Raw materials for a natural ingredient exists or originates in nature. Biological synthesis involving fermentation and enzymes can be employed, but synthesis with chemical reagents is not utilized. Artificial colors, preservatives, and flavors are not considered natural ingredients. Ingredients can be processed or purified through certain specified techniques including at least: physical processes, fermentation, and enzymolysis. Appropriate processes and purification techniques include at least: absorption, adsorption, agglomeration, centrifugation, chopping, cooking (baking, frying, boiling, roasting), cooling, cutting, chromatography, coating, crystallization, digestion, drying (spray, freeze drying, vacuum), evaporation, distillation, electrophoresis, emulsification, encapsulation, extraction, extrusion, filtration, fermentation, grinding, infusion, maceration, microbiological (rennet, enzymes), mixing, peeling, percolation, refrigeration/freezing, squeezing, steeping, washing, heating, mixing, ion exchange, lyophilization, osmose, precipitation, salting out, sublimation, ultrasonic treatment, concentration, flocculation, homogenization, reconstitution, enzymolysis (using enzymes found in nature). Processing aids (currently defined as substances used as manufacturing aids to enhance the appeal or utility of a food component, including clarifying agents, catalysts, flocculants, filter aids, and crystallization inhibitors, etc. See 21 CFR § 170.3(o)(24)) are considered incidental additives and can be used if removed appropriately.

### EXAMPLES

The sweetener compositions and beverages described herein are now further detailed with reference to the following examples. These examples are provided for the purpose of illustration only and the embodiments described herein should in no way be construed as being limited to these examples. Rather, the embodiments should be construed to encompass any and all variations which become evident as a result of the teaching provided herein.

### Example 1

Bench-Top Tasting Of Two-Way Blends

Preparation of tasting samples: Tasting samples comprising two of rebaudiosides A, D, and M at a desired concentration were prepared by dissolving the rebaudiosides in an aqueous citric acid solution containing 0.02% potassium sorbate, 0.04% sodium citrate, and 0.13% citric acid. The solution had a pH of 3.4.

The solutions were then evaluated by a taster using a “sip, spit, rinse” protocol. Under this protocol, the taster:
a. sipped up to about 10 ml of a given solution and assessed the sweetness, mouthfeel, and other characteristics of the solution during its residence in the taster's mouth;
b. spit out the solution after making the assessment; and
c. rinsed with water to cleanse the palate before testing any further samples.

The formulations described in Table 1 were analyzed.

TABLE 1

| Sample | Reb A | Reb D | Reb M | Erythritol | D-allulose | |
|---|---|---|---|---|---|---|
| No. | (ppm) | (ppm) | (ppm) | (wt %) | (wt %) | Tasting Comments |
| 1 | 0 | 100 | 300 | 0 | 0 | Sour, Bitter, Mild Sweet |
| | | | | | | Aftertaste |
| 2 | 0 | 200 | 200 | 0 | 0 | Sweet, Bitter Aftertaste and |
| | | | | | | Linger, Sour |
| 3 | 0 | 300 | 100 | 0 | 0 | Sour, Less Sweet, Aftertaste |
| 4 | 100 | 0 | 300 | 0 | 0 | Sour, Less Sweet, Bitter |
| | | | | | | Afront and Aftertaste |
| 5 | 100 | 330 | 0 | 0 | 0 | Less Sweet, More Sour, Less |
| | | | | | | Bitter, Less aftertaste |
| 6 | 200 | 0 | 200 | 0 | 0 | Astringent, Bitter after taste, |
| | | | | | | Sour, Linger |
| 7 | 200 | 200 | 0 | 0 | 0 | Astringent, Bitter aftertaste, |
| | | | | | | Mild Sweet, Linger |
| 8 | 300 | 0 | 100 | 0 | 0 | Bitter, Astringent, Sweet |
| 9 | 300 | 100 | 0 | 0 | 0 | Bitter, Astringent |
| 10 | 0 | 250 | 150 | 0 | 0 | Less Sweet, Less Sour, Less |
| | | | | | | Licorice, more bitter than Reb |
| | | | | | | D alone, Sour, Syrupy |
| | | | | | | Impression |
| 11 | 0 | 150 | 250 | 0 | 0 | Less Sweet, Sour, Tart, Less |
| | | | | | | Bitter, Less Licorice, Syrupy |
| | | | | | | Impression |

### Example 2

### Bench-Top Tasting of Three-Way Blends of Rebaudiosides A, D, and M

Three-way blends of rebaudiosides A, D, and M as shown in Table 2 were prepared in the citric acid solution described in Example 1. The resulting solutions were tasted according to the protocol described in Example 1. The results are shown in Table 2.

TABLE 2

| Sample | Reb A | Reb D | Reb M | |
|---|---|---|---|---|
| No. | (ppm) | (ppm) | (ppm) | Tasting Comments |
| 12 | 100 | 100 | 200 | Sweet & Bitter but less than |
| | | | | Reb M, Licorice, Astringent, |
| | | | | Harsher than Sample 8 |
| 13 | 100 | 200 | 100 | Less after taste, Sweet, Slight |
| | | | | Sour and Slight Bitter, Little |
| | | | | licorice |
| 14 | 200 | 100 | 100 | Balance taste, Syrupy |
| | | | | mouthfeel, Bitter aftertaste, |
| | | | | Very Sweet, Slight Bitter |
| 15 | 200 | 75 | 125 | Less Sweet, Numbing, Some |
| | | | | bitter and Linger, Sour, |
| | | | | Licorice |
| 16 | 300 | 50 | 50 | Less Sweet, Bitter, Licorice, |
| | | | | Sour, Bitter, Less Linger and |
| | | | | Numbing |

### Example 3

Bench-Top Tasting of Three-Way Blends of Rebaudiosides A, D, and M With Erythritol and/or D-allulose

The blends shown in Table 3 were prepared and tasted according to the procedures in Example 1. The results are shown in Table 3.

TABLE 3

| Sample | Reb A | Reb D | Reb M | Erythritol | D-allulose | |
|---|---|---|---|---|---|---|
| No. | (ppm) | (ppm) | (ppm) | (wt %) | (wt %) | Tasting Comments |
| 17 | 400 | 0 | 0 | 0 | 0 | Very Bitter Aftertaste, |
| | | | | | | Astringent, Licorice |
| 18 | 0 | 0 | 400 | 0 | 0 | Licorice, Bitter after taste, |
| | | | | | | Only affront sweetness |
| 19 | 0 | 400 | 0 | 0 | 0 | Less Sweet, Sour, Slightly |
| | | | | | | Bitter After Taste |
| 20 | 0 | 0 | 400 | 2.5 | 0 | Erythritol covers off-notes but |
| | | | | | | its still bitter, Lingering taste, |
| | | | | | | Similar mouthfeel to Reb M |
| | | | | | | without Erythritol |
| 21 | 0 | 400 | 0 | 2.5 | 0 | Less sweet, Slight sour, |
| | | | | | | lingering aftertaste |
| 22 | 400 | 0 | 0 | 2.5 | 0 | Bitter, Licorice |
| 23 | 0 | 0 | 400 | 0 | 2.1 | Lingering taste, Bitterness |
| | | | | | | builds, Similar mouthfeel to |
| | | | | | | Reb M without D-allulose |
| 24 | 0 | 400 | 0 | 0 | 2.1 | Less sweet, Sour |
| 25 | 400 | 0 | 0 | 0 | 2.1 | Bitter taste predominates |
| 26 | 0 | 0 | 400 | 2.5 | 2.1 | Sweet, tart, bitter, later sweet, |
| | | | | | | syrupy and visocuse than |
| | | | | | | without, bitter in the middle |
| 27 | 400 | 0 | 0 | 2.5 | 2.1 | Sweet, Very Bitter, Linger, No |
| | | | | | | significance of adding |
| | | | | | | Erythritol or D-allulose, Off- |
| | | | | | | taste |
| 28 | 0 | 400 | 0 | 2.5 | 2.1 | Sweet, Tart, Bitter Linger, |
| | | | | | | Licorice sweet, bitter on back |
| | | | | | | end, affront roundness, |
| 29 | 0 | 200 | 200 | 2.5 | 2.1 | bitter on backend, very sweet |
| | | | | | | and some numbing in the back, |
| | | | | | | Syrupy |
| 30 | 200 | 100 | 100 | 0 | 2.1 | Sweet, Less Sour, Slight Bitter, |
| 31 | 200 | 100 | 100 | 2.5 | 0 | Sweet, Slight Sour, Slight |
| | | | | | | Bitter |
| 32 | 200 | 100 | 100 | 2.5 | 2.1 | Ranked the best clean taste, |
| | | | | | | Low bitterness, Syrupy, |
| | | | | | | Rounded Sweet, Less Sour, |
| | | | | | | Higher mouthfeel |
| 33 | 200 | 100 | 100 | 0 | 0 | Balance taste, Syrupy |
| | | | | | | mouthfeel, Bitter aftertaste, |
| | | | | | | Very Sweet, Slight Bitter |

### Example 4

### Trained Sensory Panel Analysis

Sensory panel tastings of three-way blends of rebaudiosides A, D, and M in the citric acid solution described in Example 1 were performed by trained panelists.

In a first set of experiments, rebaudiosides A, D, M, and sucrose were individually tested by 14 panelists with three evaluations each.

Combination samples of rebaudiosides A, D, and M at a ratio of 2:1:1 with or without erythritol and D-allulose were tested by 15 panelists with two evaluations each. The formulations of the samples are shown in Table 4. A sample of 6.5% sucrose was used as a control.

TABLE 4

| Sample | Reb A | Reb D | Reb M | Erythritol | D-allulose |
|---|---|---|---|---|---|
| No. | (ppm) | (ppm) | (ppm) | (wt %) | (wt %) |
| 17 | 400 | 0 | 0 | 0 | 0 |
| 33 | 0 | 408 | 0 | 0 | 0 |
| 34 | 0 | 0 | 304 | 0 | 0 |
| 14 | 200 | 100 | 100 | 0 | 0 |
| 30 | 200 | 100 | 100 | 0 | 2.1 |
| 31 | 200 | 100 | 100 | 2.5 | 0 |

For the evaluations, the panelists evaluated two samples during each session with two such sessions being held in a 2-hour testing period. A 15-minute break was taken between samples. Room temperature drinking water and unsalted soda crackers were provided for cleansing the palate between samples. The panelists indicated the intensity of key flavor and feeling factor attributes of the test sample (labeled with a 3-digit number) on a 15-point line scale with slash marks.

The slash marks on the line scales were converted to numbers ranging from 0 to 15 by SIMS (Sensory Information Management System). Mean intensities were then calculated for each sensory characteristic. Analysis of Variance and then Tukey's Multiple Comparison Test (where appropriate) were used to determine significant differences among the samples for each attribute. When panelist-by-product interactions were significant, the mean square of the interaction term, instead of the mean square of the error term, was used in calculation of product F values. α≤0.10 was used as the criterion for a significant difference. Samples were evaluated in a sensory test facility with individually partitioned booths. The booth area was designed to minimize visual contact between panelists.

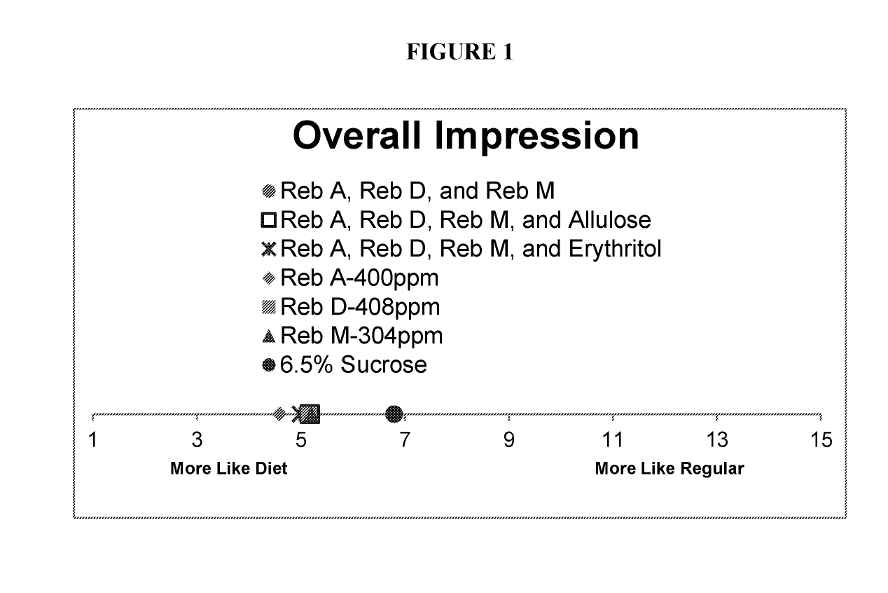

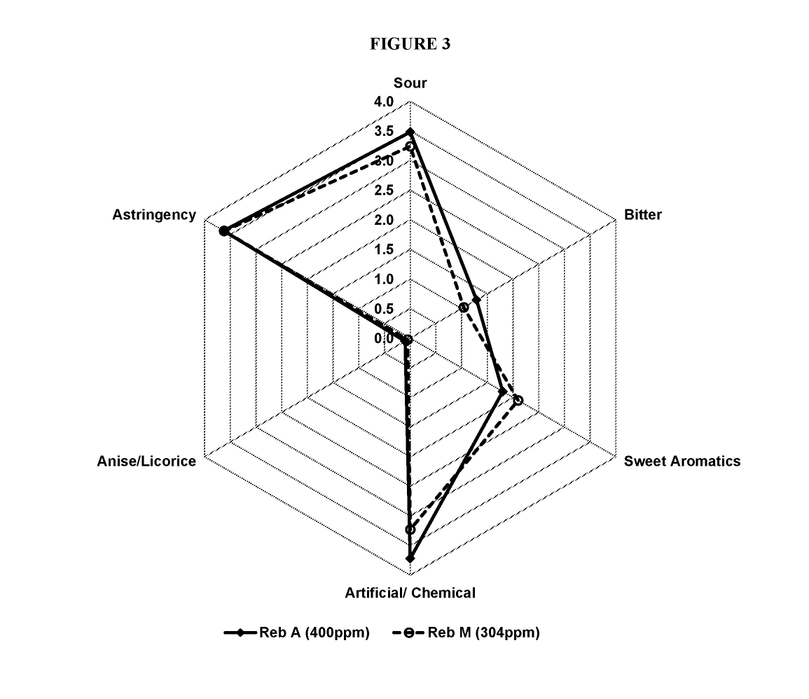

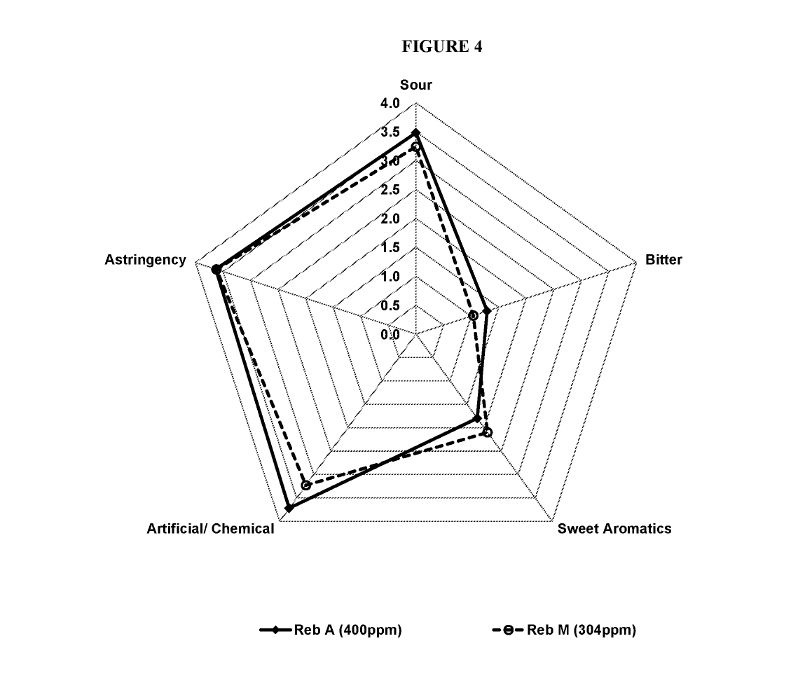

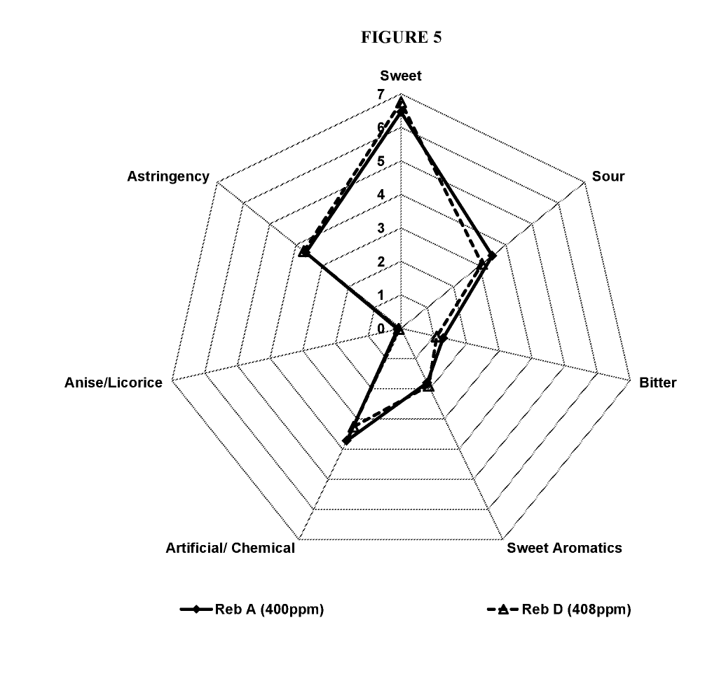

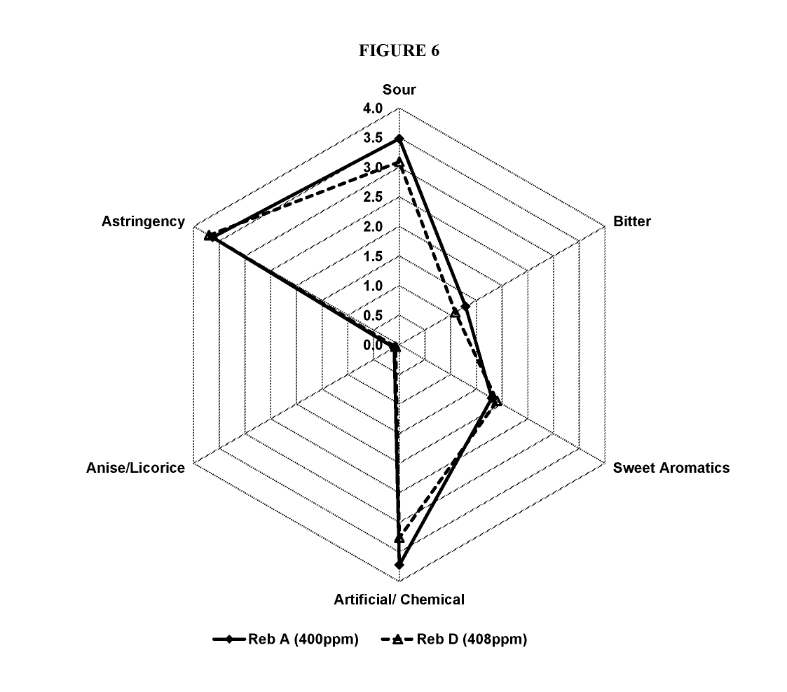

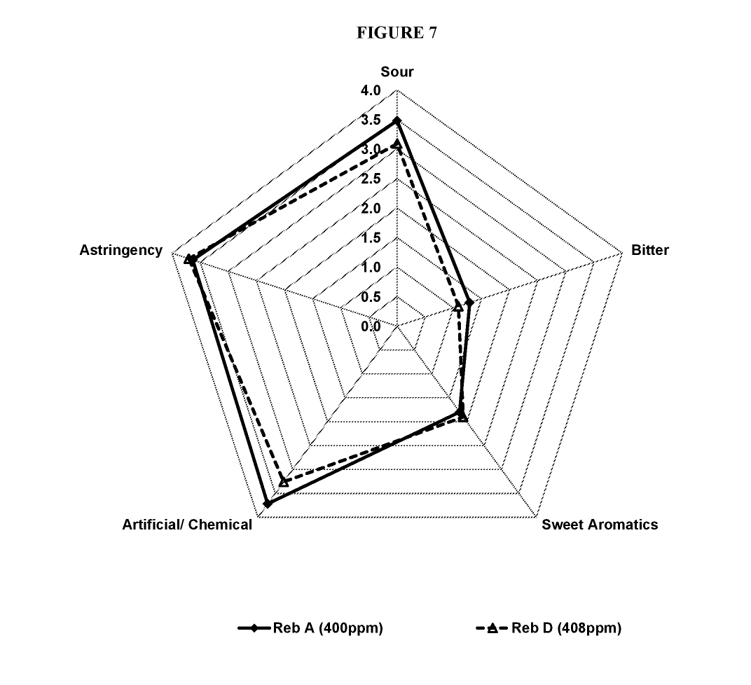

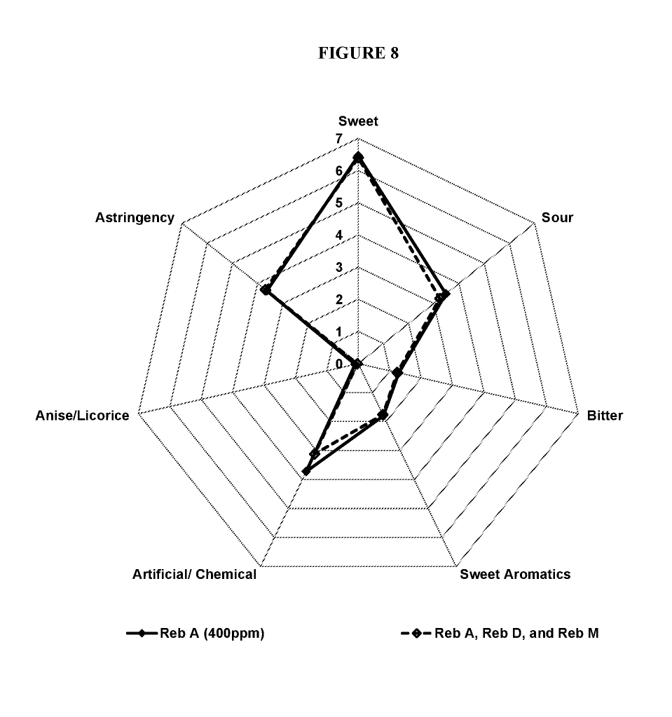

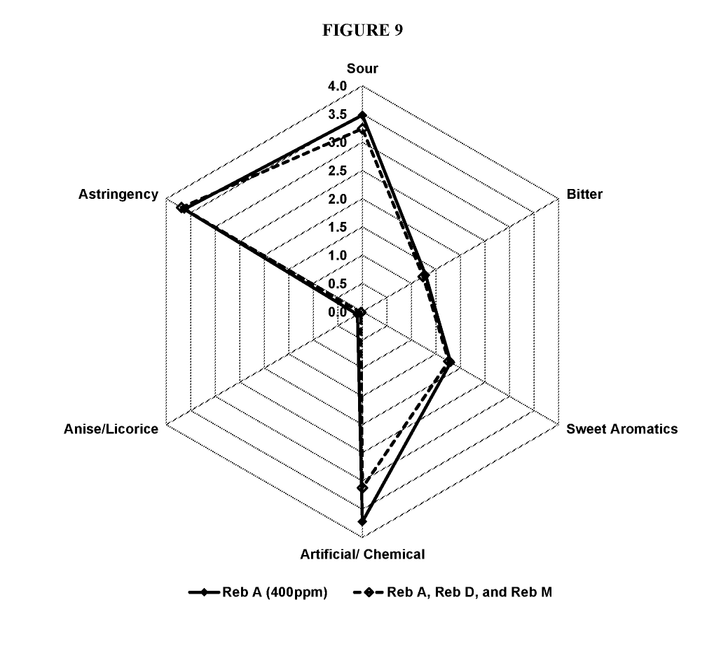

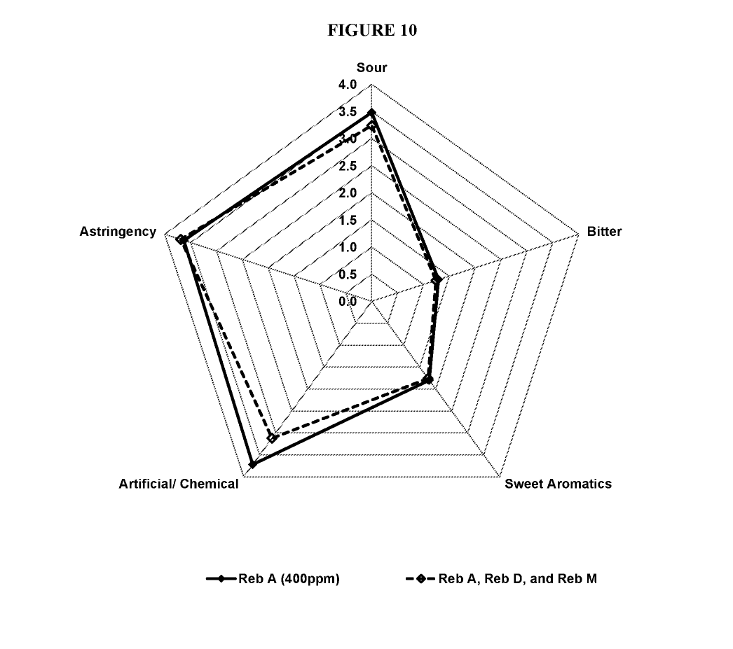

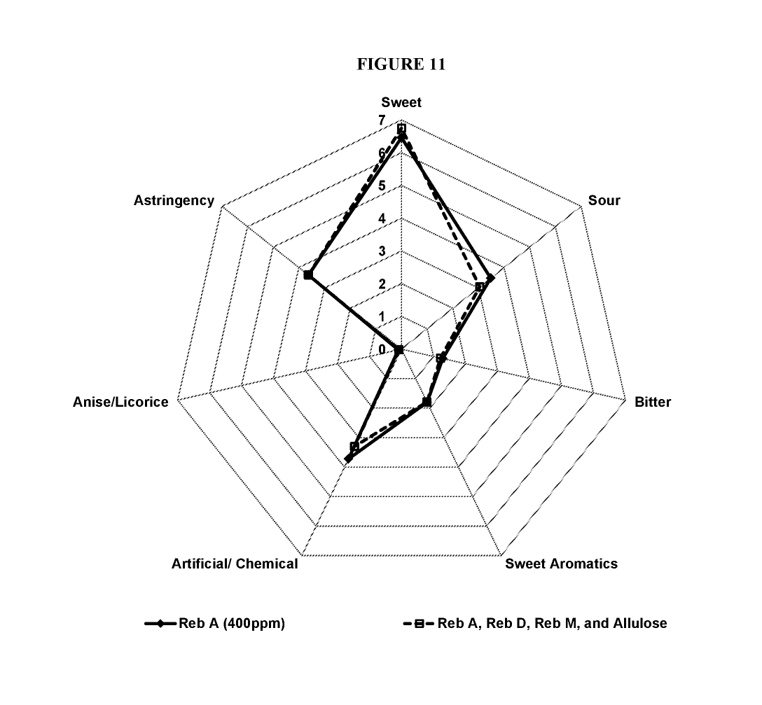

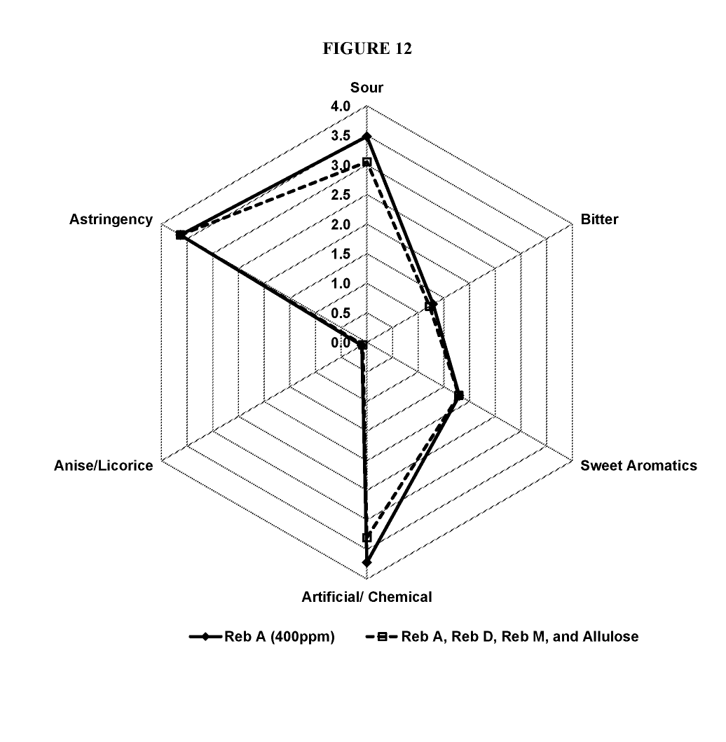

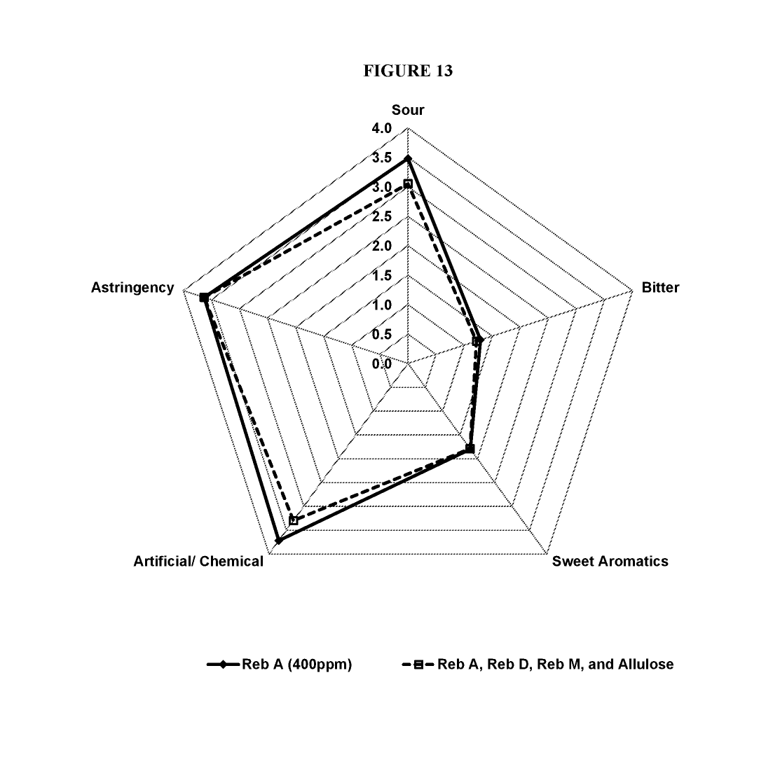

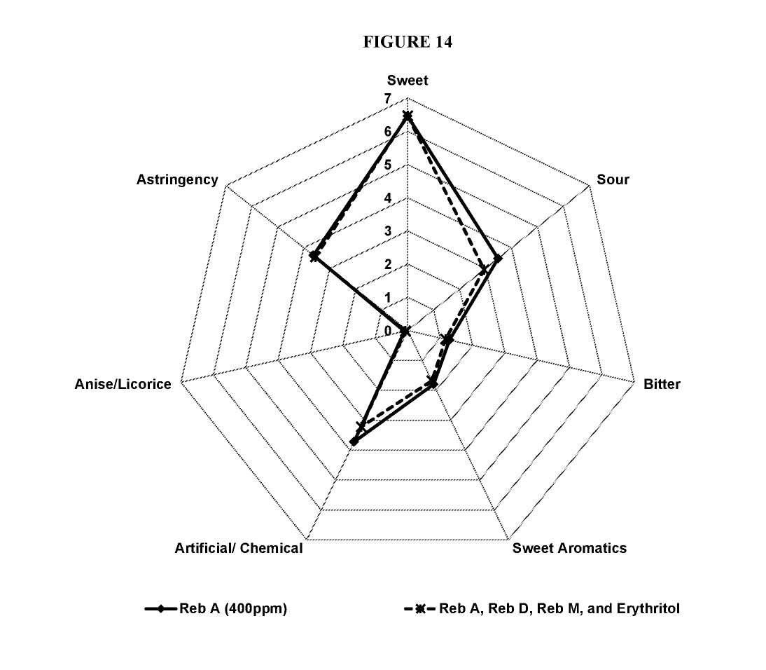

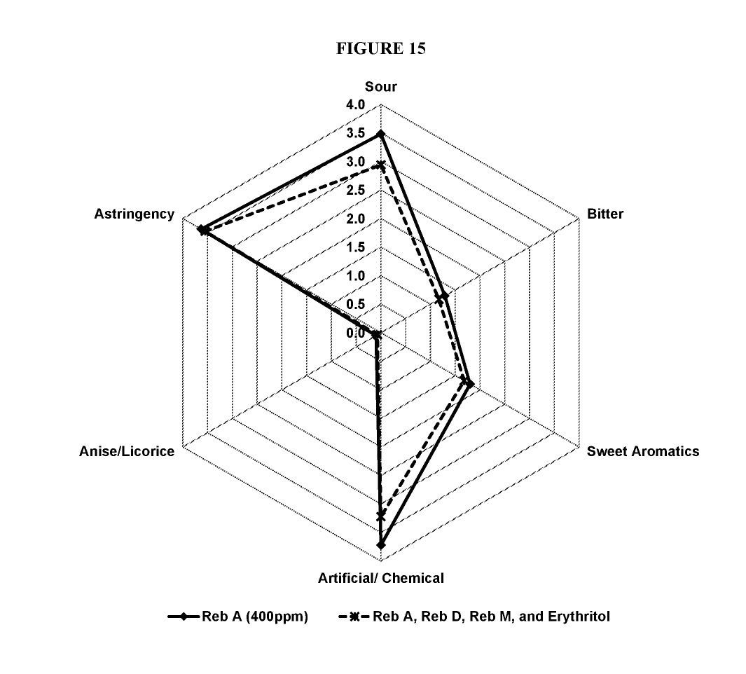

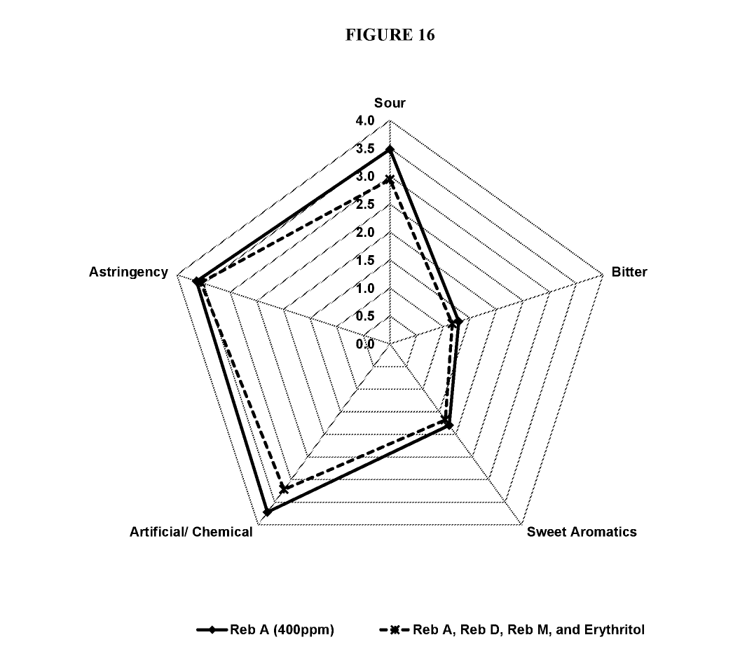

The tasting results are shown in FIGS. 1-18. FIG. 1 shows overall impression of the panelists for individual and combination rebaudioside samples when the panelists evaluated the samples at five seconds. The panelists assessed whether a sample was diet-like or regular. Rebaudioside A was perceived to be diet-like. Combination samples were significantly less diet-like than rebaudioside A.

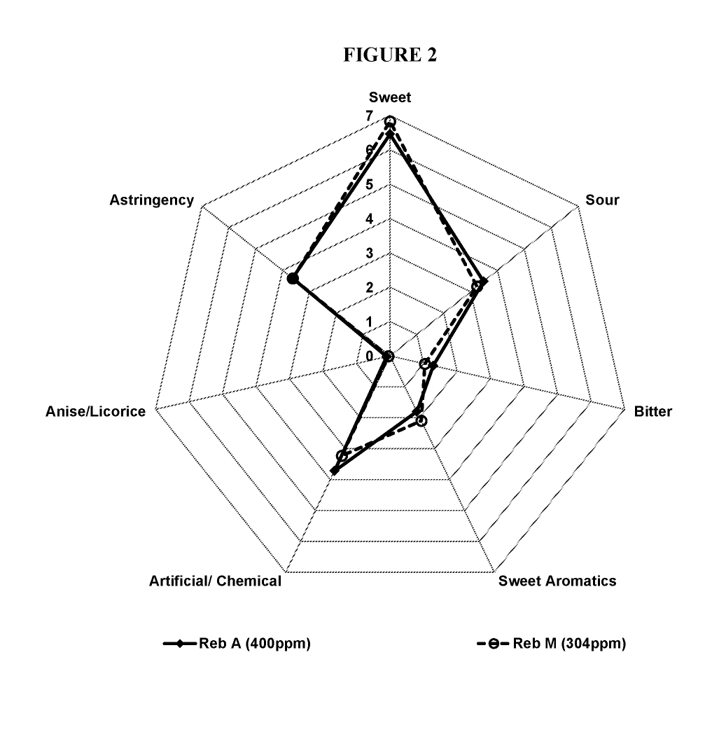

FIGS. 2-16 shows the intensities of various attributes of individual and combination rebaudioside samples when evaluated at five seconds. Reb D, Reb M, and combination samples were compared to a Reb A sample. Combination samples with or without erythritol and D-allulose had significantly lower sour taste and artificial/chemical off-note.

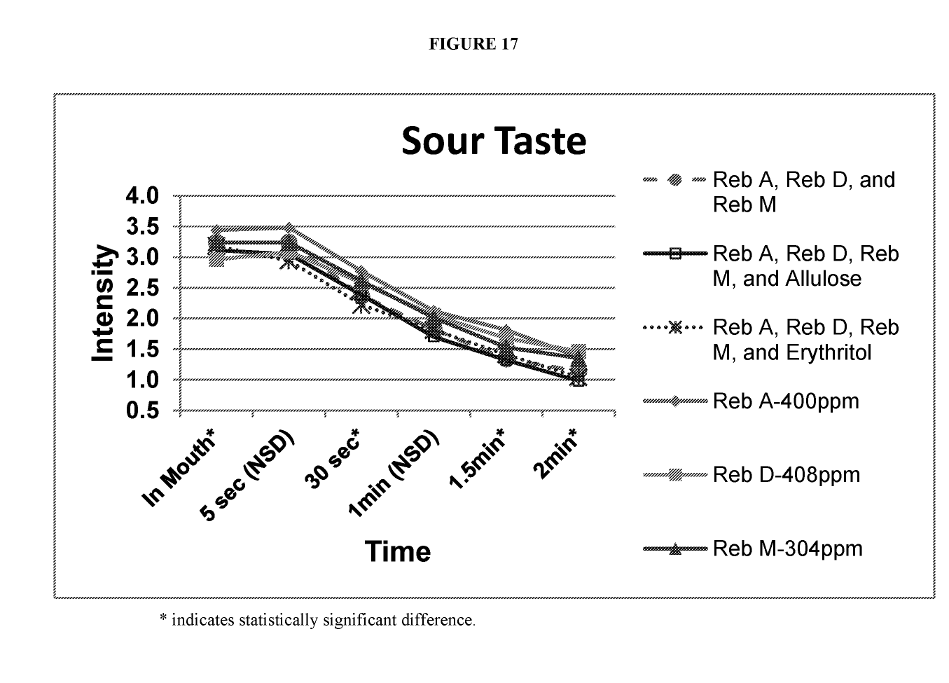

FIG. 17 shows the sour taste intensity of the various samples when evaluated at specific time points. Combination samples with or without erythritol and D-allulose had significantly lower sour taste than rebaudioside A when evaluated at 30 seconds and two minutes. Combination samples with erythritol and D-allulose had lower sour taste than rebaudioside D when evaluated at two minutes.

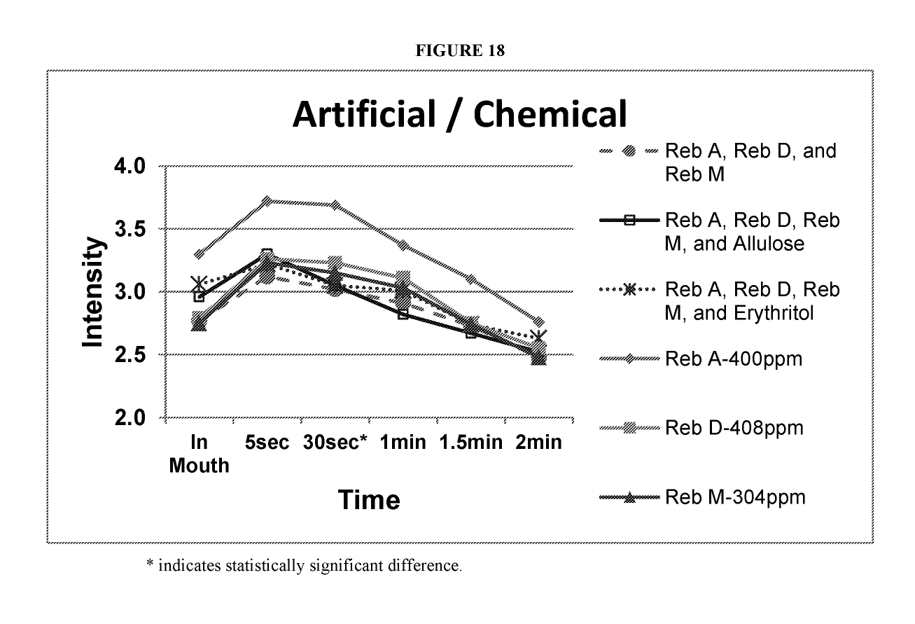

FIG. 18 shows the artificial/chemical off-notes observed when the samples were evaluated at 30 seconds. Rebaudioside A had a significantly higher artificial/chemical off-note compared to rebaudioside M and combination samples with or without erythritol or D-allulose.

### Example 5

### Targeted Descriptive Analysis

Targeted Descriptive Analysis (TDA) was conducted by trained panelists to evaluate the sweet quality of the beverage samples listed below. The sweet qualities evaluated included sweetness, sourness, bitterness, sweet aromatics, anise/licorice taste, metallic taste, astringency, viscosity, chemical/artificial taste, total aftertaste, sweetness onset, and overall impression.

Tasting samples were prepared in an aqueous phosphoric acid solution with a pH of 3.1, containing approximately 0.01% phosphoric acid. The pH was checked again after adding sample ingredients to make sure the pH was still 3.1.

| | Reb A | Reb D | Reb M | Erythritol | D-allulose |
|---|---|---|---|---|---|
| Formulations | (ppm) | (ppm) | (ppm) | (wt %) | (wt %) |
| Sample 40 | 200 | 100 | 100 | 2.5 | 2.1 |
| Sample 41 | 100 | 100 | 200 | 0 | 0 |
| Sample 42 | 400 | 0 | 0 | 0 | 0 |

Nine trained panelists evaluated the samples in three sessions. Each sample was evaluated three times by a panelist (i.e., repeated measures), once in each session. The panelists evaluated 45 mL portions of each sample, using a sip-and-swallow method. The tasting procedures are describe below:
1. Nose clips were not worn for the TDA evaluations.
2. The panelists began by rinsing their mouths at least 3 times with water to cleanse their palates.
3. The panelists then tasted the first sample, by taking a sip, swirling it in their mouths for 10 seconds, and then swallowing. The Panelists rated the intensity of sweetness, sourness, bitterness, sweet aromatics, anise/licorice taste, metallic taste, astringency, viscosity, chemical/artificial taste, total aftertaste, sweetness onset, and overall impression. They rinsed 6 times with water to cleanse their palates. They then repeated this tasting process 2-3 more times until they completed rating all of the attributes on a sensory ballot for the first sample. The attributes were rated on a scale of 0-15.
4. The panelists rinsed 6 more times with water and took a break of at least 15 minutes.
5. Steps 2-4 were repeated until all samples had been evaluated one time.
6. The panelists rinsed 6 more times with water and took a break of at least 15 minutes.
7. Steps 2-5 were repeated until all samples had been evaluated for a second time.
8. The panelists rinsed 6 more times with water and took a break of at least 15 minutes.
9. Steps 2-5 were repeated until all samples had been evaluated for a third time.

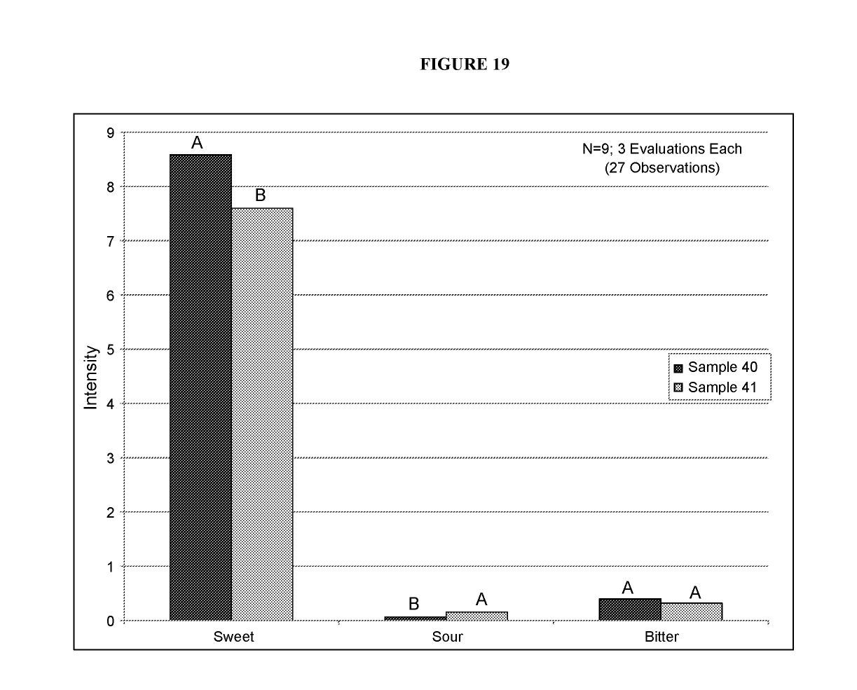

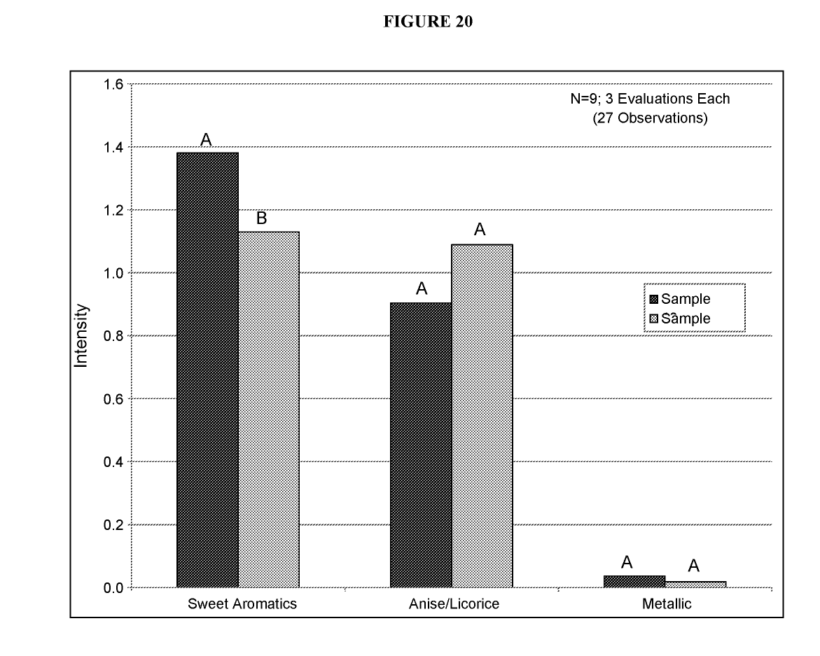

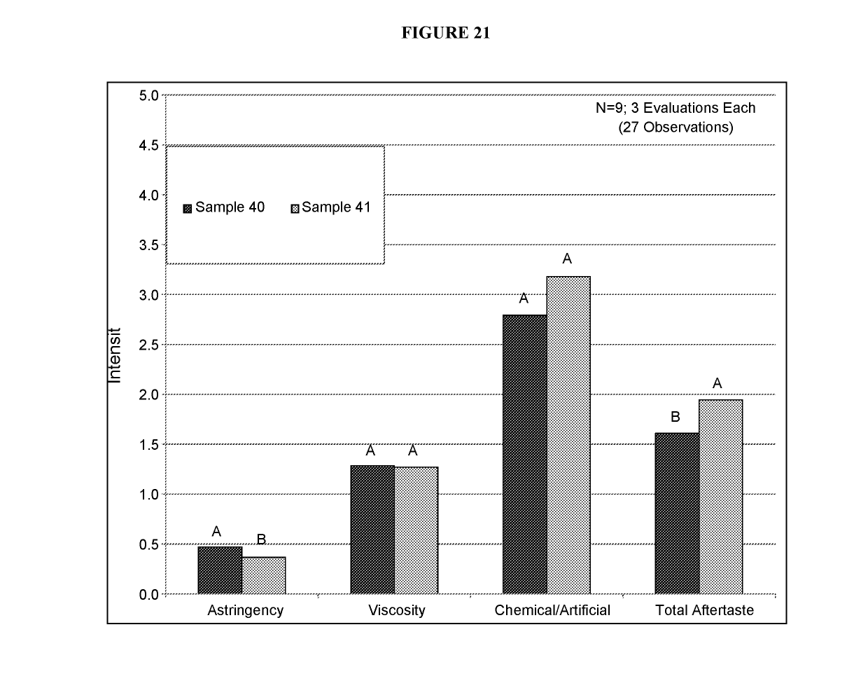

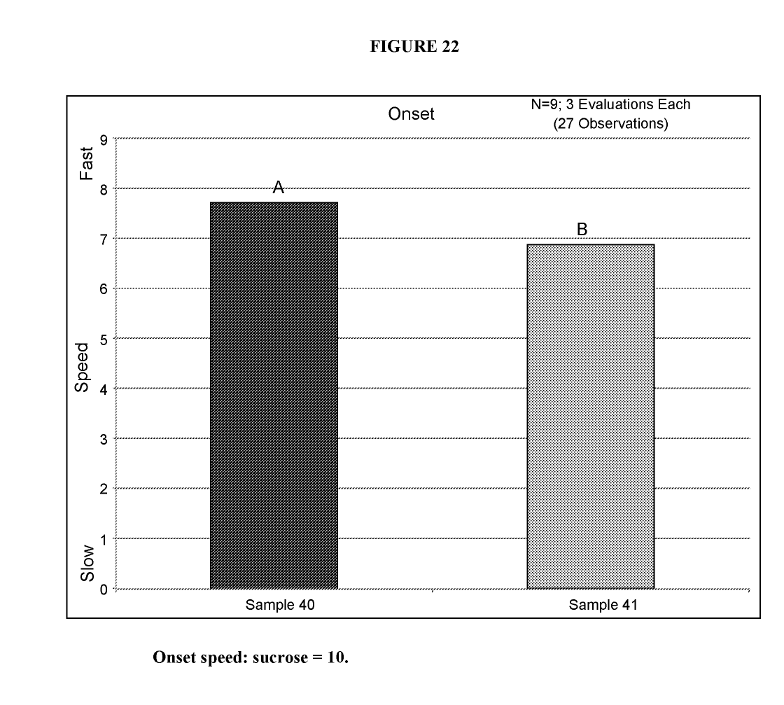

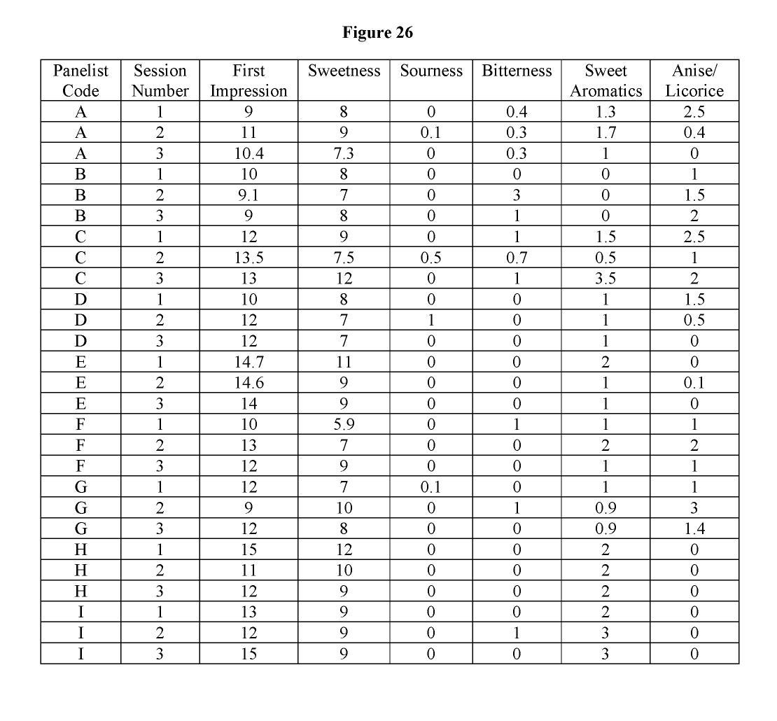

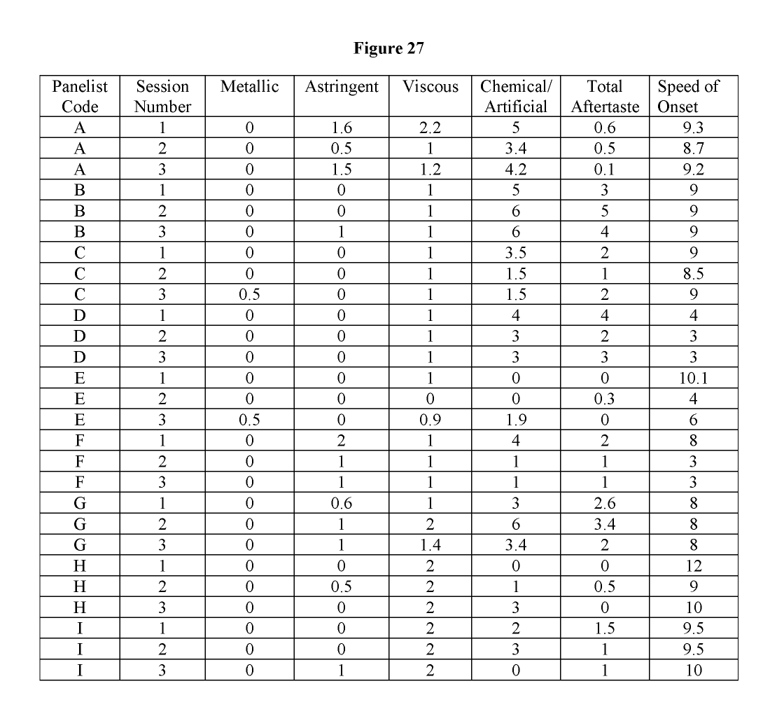

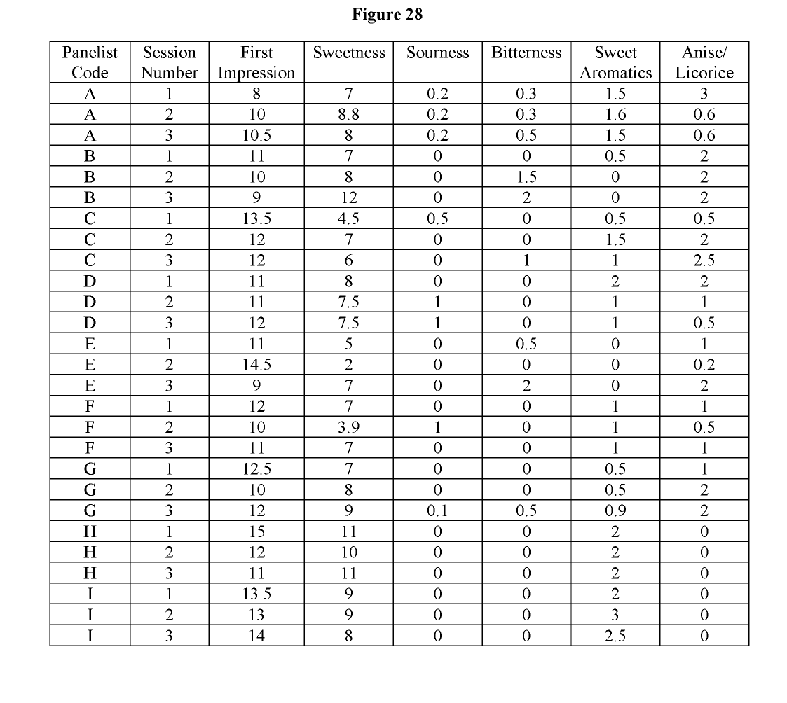

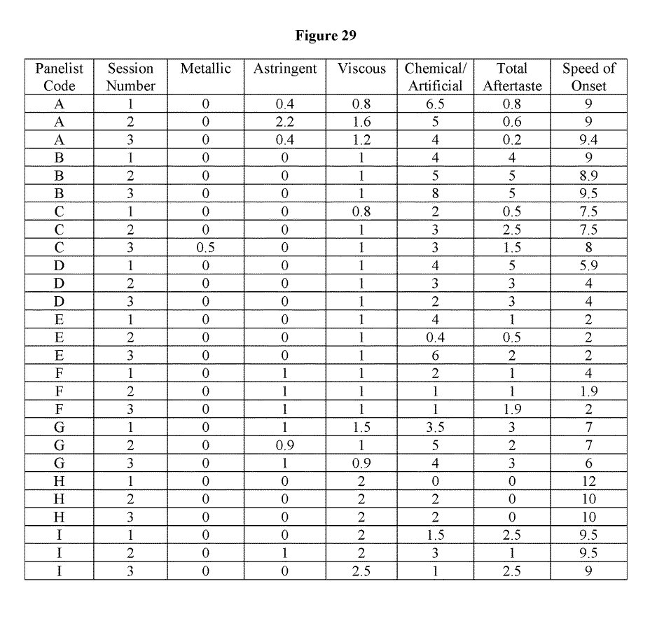

The TDA ratings by the panelists are shown in FIGS. 26-27 (sample 40) and FIGS. 28-29 (sample 41). The TDA data was analyzed using Analysis of Variance (ANOVA) and the General Linear Model (GLM) in MINITAB 16. The comparison between samples 40 and 41 are summarized in Table 5 below and FIGS. 19-22. In the figures, the labels “A” and “B” indicate a statistically significant difference between the attributes of two samples. For example, a sample with a label “A” is statistically significantly different from a second sample with a label “B.” On the contrary, a sample with a label “A” or “B” is not statistically significantly different from another sample with a label “AB.”

TABLE 5

| | | Confidence |
|---|---|---|
| Entry | Results | Level |
| 1 | Sample 40 significantly higher | 80% |
| | than sample 41 in sweetness | |
| 2 | Sample 40 significantly lower | 90% |
| | than sample 41 in sourness | |
| 3 | Sample 40 significantly higher | 80% |
| | than sample 41 in sweet aromatics | |
| 4 | Sample 40 significantly higher | 90% |
| | than sample 41 in astringency | |
| 5 | Sample 40 significantly lower | 90% |
| | than sample 41 in total aftertaste | |
| 6 | Sample 40 significantly faster | 80% |
| | than sample 41 in sweetness onset | |

Samples 40 and 41 were similar beverage compositions, both containing a blend of Rebaudiosides A, D, and M. But despite their similarities, it was surprisingly discovered that sample 40 had much better overall sweet qualities attributable to a subtle shift in the beverage's formulation. For example, sample 40 had significantly higher sweetness and sweet aromatics but significantly lower sourness and total after taste than sample 41. Sample 40 also had a significantly faster sweetness onset speed than sample 41. Sample 40, however, had significantly higher astringency than sample 41.

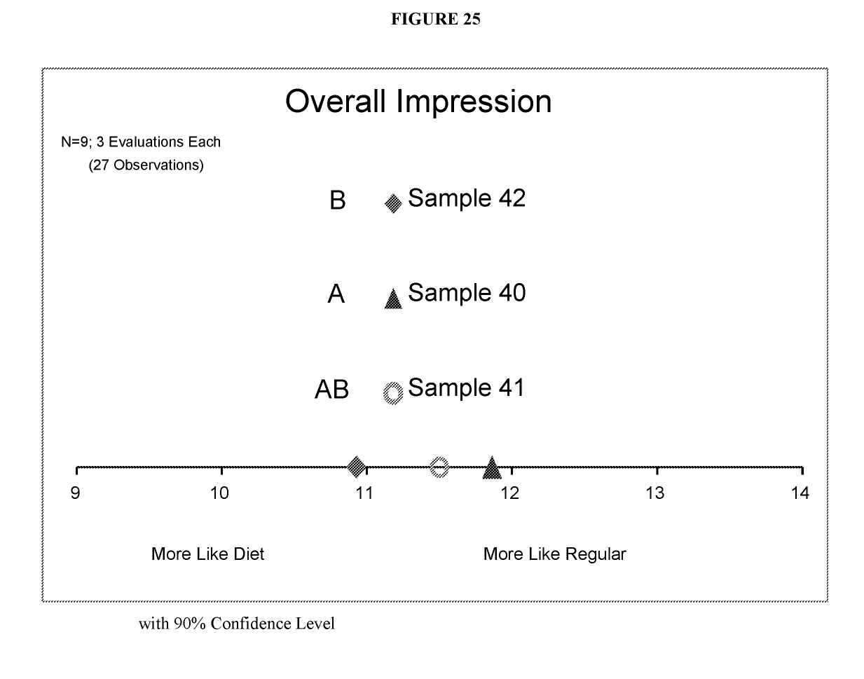

The panelists also assessed whether a sample was diet-like or regular. FIG. 25 shows the overall impression of the panelists for samples 40, 41, and 42. A solution of 8% sucrose in water was used as a reference with a rating of 15. Rebaudioside A (sample 42) was perceived to be diet-like. Sample 40 was significantly less diet-like than rebaudioside A at a confidence level of 90%. Sample 40 was also less diet-like than sample 41.

### Example 6

### Taste Adaption

Taste adaptation was used to evaluate the effect of multiple sips on sweet taste and bitter taste perception. The two formulations (samples 40 and 41) as prepared in Example 5 were evaluated by nine trained panelists.

Each sample was evaluated twice (i.e., repeated measures). The panelists evaluated 60 mL portions of each sample, using a sip-and-swallow method. The panelists evaluated both samples twice in one day, with long breaks between the samples.

The two samples were evaluated in a balanced order for each panelist, and the sample presentation order was different for the first and second evaluation for each panelist. The tasting procedures are describe below:
1. Nose clips were worn for the Taste Adaptation evaluations.
2. The panelists began by rinsing their mouths at least 3 times with water to cleanse their palates.
3. The panelists then tasted the first sample, by taking a sip, swirling it in their mouths for 10 seconds, and then swallowing. They rated the intensity of sweet taste and bitter taste.
4. 30 seconds after swallowing and without rinsing, the panelists took a second sip of the same sample, swirling it in their mouths for 10 seconds, and then swallowing. They again rated the intensity of sweet taste and bitter taste.
5. Steps 3-4 were repeated until a total of 7 sips of the first sample had been evaluated.
6. After rinsing 6 times with water and taking a break of at least 15 minutes, the panelists repeated steps 2-5 for the second sample.
7. On the same day (with a 15 minute break between the two samples) steps 2-6 were repeated for the second evaluation of each sample.

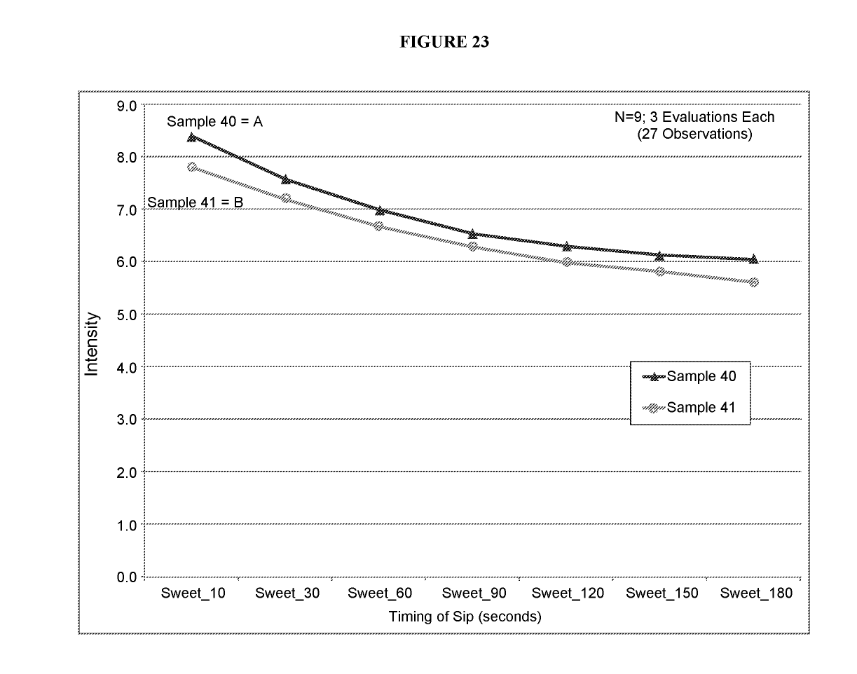

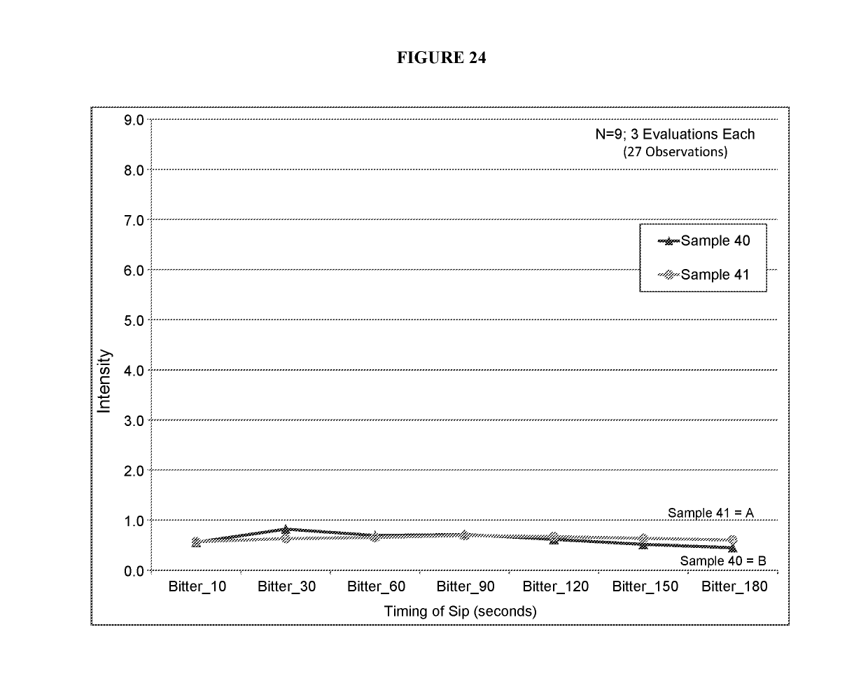

The taste adaptation data was analyzed using Analysis of Variance (ANOVA) and the General Linear Model (GLM) in MINITAB 16. The comparison between samples 40 and 41 are summarized in Table 6 below and FIGS. 23 and 24.

TABLE 6

| | | Confidence |
|---|---|---|
| Entry | Results | Level |
| 1 | Sample 40 significantly higher than sample 41 in | 80% |
| | sweetness for 1st sip (adaptation) | |
| 2 | Sample 40 significantly lower than sample 41 in | 85% |
| | bitterness for 7th sip (sensitization) | |

The taste adaptation results also show that sample 40 surprisingly had better sweet qualities than sample 41. FIG. 23 shows that sample 40 had a higher sweetness for all seven sips during the evaluation, and had a significantly higher sweetness for the first sip. FIG. 24 shows that sample 40 had a significantly low bitterness for the 7th sip. Here again, the statistical differences in taste were highly unexpected given the similarities in these formulations, showing that even minor changes in a rebaudioside mixture formulation can have a significant impact on how the flavor of the mixture is perceived.

While this disclosure mentions specific examples and embodiments, those skilled in the art will appreciate that there are numerous variations and modifications within the spirit and scope of the disclosure as set forth in the appended claims.

What is claimed is:

1. A beverage comprising water, an acid, rebaudioside A, rebaudioside D, rebaudioside M, erythritol, and D-allulose,
wherein rebaudioside A is present in the beverage in a concentration ranging from about 100 ppm to about 300 ppm and wherein each of rebaudiosides D and M is present in the beverage in a concentration ranging from about 50 ppm to about 150 ppm; further wherein:
a ratio of the concentrations of rebaudioside A to rebaudioside D is about 2:1;
a ratio of the concentrations of rebaudioside A to rebaudioside M is about 2:1;
D-allulose is present in a sweetening amount, but not more than about 2.1 weight percent; and
erythritol is present in a sweetening amount, but not more than about 2.5 weight percent.

2. The beverage of claim 1, wherein the concentration of rebaudioside A is about 100 ppm.

3. The beverage of claim 1, wherein the concentration of rebaudioside A is about 200 ppm.

4. The beverage of claim 1, wherein the beverage exhibits a statistically significant reduction in sourness relative to a comparative beverage comprising 200 ppm rebaudioside M, 100 ppm rebaudioside A, and 100 pm rebaudioside D.

5. The beverage of claim 1, wherein the beverage exhibits a statistically significant increase in sweetness relative to a comparative beverage comprising 200 ppm rebaudioside M, 100 ppm rebaudioside A, and 100 pm rebaudioside D.

6. The beverage of claim 1, wherein the beverage exhibits a statistically significant increase in speed of sweetness onset relative to a comparative beverage comprising 200 ppm rebaudioside M, 100 ppm rebaudioside A, and 100 pm rebaudioside D.

7. The beverage of claim 1, wherein the beverage exhibits a statistically significant reduction in total aftertaste relative to a comparative beverage comprising 200 ppm rebaudioside M, 100 ppm rebaudioside A, and 100 pm rebaudioside D.

8. The beverage of claim 1, wherein the beverage exhibits a statistically significant increase in sweet aromatics relative to a comparative beverage comprising 200 ppm rebaudioside M, 100 ppm rebaudioside A, and 100 pm rebaudioside D.

9. The beverage of claim 1, wherein the beverage exhibits a statistically significant increase of sweetness in sweet adaption at about 10 seconds relative to a comparative beverage comprising 200 ppm rebaudioside M, 100 ppm rebaudioside A, and 100 pm rebaudioside D.

10. The beverage of claim 1, wherein the beverage exhibits a statistically significant reduction of bitterness in bitter sensitization at about 180 seconds relative to a comparative beverage comprising 200 ppm rebaudioside M, 100 ppm rebaudioside A, and 100 pm rebaudioside D.

11. The beverage of any of claims 4-10, wherein the statistical significance is observed at at least an 80% confidence level.

12. The beverage of any of claims 4-10, wherein the statistical significance is observed at at least an 85% confidence level.

13. The beverage of any of claim 4-10, wherein the statistical significance is observed at at least a 90% confidence level.

14. A beverage syrup comprising water, an acid, rebaudioside A, rebaudioside D, rebaudioside M, erythritol, and D-allulose,
wherein rebaudioside A is present in the beverage in a concentration ranging from about 600 ppm to about 1200 ppm and wherein each of rebaudiosides D and M is present in the syrup in a concentration ranging from about 300 ppm to about 600 ppm; further wherein:
a ratio of the concentrations of rebaudioside A to rebaudioside D is about 2:1;
a ratio of the concentrations of rebaudioside A to rebaudioside M is about 2:1;
D-allulose is present in an amount of at least 6.3 weight percent, but not more than about 12.6 weight percent; and
erythritol is present in an amount of at least 7.5 weight percent, but not more than about 15 weight percent.

15. A sweetener composition comprising rebaudioside A, rebaudioside D, rebaudioside M, erythritol, and D-allulose, wherein:
a weight ratio of rebaudioside A to rebaudioside D is about 2:1;
a weight ratio of rebaudioside A to rebaudioside M is about 2:1;
a weight ratio of rebaudioside A to D-allulose is about 1:90 to about 1:120; and
a weight ratio of rebaudioside A to erythritol is from about 1:110 to about 1:140.

16. The sweetener composition of claim 15, wherein the weight ratio of rebaudioside A to erythritol is about 1:125.

17. The sweetener composition of claim 16, wherein the weight ratio of rebaudioside A to D-allulose is about 1:105.
